(19) United States
(12) Patent Application Publication
(10) Pub. No.: US 2012/0099414 A1
(43) Pub. Date: Apr. 26, 2012

(54) OPTICAL PICKUP DEVICE

(75) Inventor: Kenji Nagatomi, Kaizu-City (JP)

(73) Assignee: Sanyo Electric Co., Ltd., Moriguchi-shi (JP)

(21) Appl. No.: 13/282,216

(22) Filed: Oct. 26, 2011

(30) Foreign Application Priority Data
Oct. 26, 2010 (JP) 2010-239909

(51) Int. Cl. G11B 7/135

(52) U.S. Cl. 369/112.23; G9B/7.112

(57) ABSTRACT

An astigmatism element converges reflected light to generate focal lines, and a light separating element separates light fluxes of the reflected light entered into four first areas from each other. Two of the first areas are disposed in a direction along which a pair of vertically opposite angles defined by first and second straight lines are aligned, and the other two of the first areas are disposed in a direction along which the other pair of vertically opposite angles are aligned. Each of the four first areas is divided into two segment areas by a second area. The reflected light to be entered into the second area is guided to a position on the outside of sensors of a photodetector, and light fluxes of the reflected light to be entered into the paired segment areas are irradiated, on the photodetector, at positions away from each other.

This application claims priority under 35 U.S.C. Section 119 of Japanese Patent Application No. 2010-239909 filed Oct. 26, 2010, entitled “OPTICAL PICKUP DEVICE”. The disclosure of the above application is incorporated herein by reference.

### BACKGROUND OF THE INVENTION

1. Technical Field of the Invention

The invention relates to an optical pickup device, and more particularly to a device suitable for use in irradiating a recording medium having plural laminated recording layers with laser light.

2. Disclosure of Related Art

In recent years, the number of recording layers has been increasing in accordance with a demand for an increase in the data capacity of an optical disc. The data capacity of a disc can be remarkably enhanced by forming plural recording layers in the disc. In the case where recording layers are laminated, generally, two layers are formed on one side of a disc. In recent years, however, a disc having three or more recording layers on one side thereof has been put into practical use in order to further increase the data capacity. An increase in the number of laminated recording layers enables to increase the data capacity of a disc. An increase in the number of laminated recording layers, however, may narrow the interval between the recording layers, and increase signal degradation resulting from an interlayer crosstalk.

As the number of recording layers to be laminated is increased, reflection light from a recording layer (a targeted recording layer) to be recorded/reproduced is reduced. As a result, if unwanted reflection light (stray light) is entered into a photodetector from a recording layer on or under the targeted recording layer, a detection signal may be deteriorated, which may adversely affect focus servo control and tracking servo control. In view of this, in the case where a large number of recording layers are laminated, it is necessary to properly remove stray light, and stabilize a signal from a photodetector.

Japanese Unexamined Patent Publication No. 2009-211770 (corresponding to U.S. Patent Application Publication No. US2009/0225645 A1) discloses a novel arrangement of an optical pickup device operable to properly remove stray light, in the case where a large number of recording layers are formed. With this arrangement, it is possible to form an area where only signal light exists, on a light receiving surface of a photodetector. By disposing a sensor of the photodetector in the above area, it is possible to suppress an influence on a detection signal resulting from stray light.

In the above optical pickup device, although an area where only signal light exists can be formed on the light receiving surface of the photodetector, stray light may be entered into a sensor disposed on the photodetector, and the precision of a detection signal may be lowered, because an area onto which signal light is irradiated and an area onto which stray light is irradiated are adjacent to each other. Further, in the optical pickup device, use of a disc having a small distance between recording layers may make it difficult to discriminate an S-shaped curve in performing focus servo control, which may make it difficult to discriminate a recording layer. Further, in the optical pickup device, if the position of a sensor disposed on the photodetector is displaced, a detection signal may be degraded depending on the amount of positional displacement.

### SUMMARY OF THE INVENTION

An optical pickup device according to a main aspect of the invention includes a laser light source; an objective lens which focuses laser light emitted from the laser light source on a recording medium; an astigmatism element into which reflected light of the laser light reflected on the recording medium is entered, and which converges the reflected light in a first direction to generate a first focal line, and converges the reflected light in a second direction perpendicular to the first direction to generate a second focal line; a light separating element into which the reflected light is entered, and which separates light fluxes of the reflected light entered into four first areas from each other; and a photodetector which receives the separated light fluxes to output a detection signal. In the above arrangement, assuming that an intersection of first and second straight lines respectively in parallel to the first direction and the second direction and intersecting with each other is aligned with a center of the light separating element, two of the first areas are disposed in a direction along which a pair of vertically opposite angles defined by the first and second straight lines are aligned, and the other two of the first areas are disposed in a direction along which the other pair of vertically opposite angles defined by the first and second straight lines are aligned. The four first areas are divided by a second area having a predetermined width, and each of the four first areas is divided into two segment areas by a third straight line intersecting the first and second straight lines at an angle of 45 degrees, or a fourth straight line perpendicularly intersecting the third straight line. Further, the light separating element is configured in such a manner that the reflected light to be entered into the second area is guided to a position on the outside of sensors of the photodetector, and is configured in such a manner that light fluxes of the reflected light to be entered into the paired segment areas are irradiated, on the photodetector, at positions away from each other by a predetermined clearance, and the photodetector is provided with the sensors which individually receive a light flux to be entered into each of the segment areas.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams for describing a technical principle (as to how light rays converge) in an embodiment of the invention.

FIGS. 2A through 2D are diagrams for describing the technical principle (as to how light fluxes are distributed) in the embodiment.

FIGS. 3A through 3D are diagrams for describing the technical principle (as to how signal light and stray light are distributed) in the embodiment.

FIGS. 4A and 4B are diagrams for describing the technical principle (a method for separating light fluxes) in the embodiment.

FIGS. 5A through 5D are diagrams for describing a method for arranging sensors in the embodiment.

FIG. 6 is a diagram showing a preferable range to which the technical principle of the embodiment is applied.

FIGS. 7A through 7D are schematic diagrams showing an arrangement of a light separating element based on the technical principle of the embodiment, and an irradiation area in the case where the light separating element is used.

FIGS. 8A and 8B are schematic diagrams showing how an irradiation area is shifted in the case where the light separating element based on the technical principle of the embodiment is used.

FIGS. 9A through 9C are schematic diagrams showing a SUM signal and a focus error signal, in the case where the light separating element based on the technical principle of the embodiment is used.

FIGS. 10A and 10B are diagrams showing a modification example of the light separating element based on the technical principle of the embodiment.

FIGS. 11A through 11C are schematic diagrams showing irradiation areas, in the case where the modification example of the light separating element based on the technical principle of the embodiment is used.

FIGS. 12A and 12B are schematic diagrams showing how the irradiation area is shifted, in the case where the modification example of the light separating element based on the technical principle of the embodiment is used.

FIGS. 13A through 13C are schematic diagrams showing a SUM signal and a focus error signal, in the case where the modification example of the light separating element based on the technical principle of the embodiment is used.

FIGS. 14A through 14D are diagrams showing simulation results on the irradiation area based on the technical principle of the embodiment.

FIGS. 15A through 15D are diagrams showing simulation results on the irradiation area based on the technical principle of the embodiment.

FIG. 16 is a diagram showing a simulation result on the irradiation area based on the technical principle of the embodiment.

FIGS. 17A through 17F are diagrams for describing an output signal from each sensor when the position of the sensors is displaced, in the case where the light separating element based on the technical principle of the embodiment is used.

FIGS. 18A and 18B are diagrams showing another modification example of the light separating element based on the technical principle of the embodiment.

FIGS. 19A through 19C are schematic diagrams showing irradiation areas, in the case where another modification example of the light separating element based on the technical principle of the embodiment is used.

FIGS. 20A through 20F are diagrams for describing an output signal from each sensor when the position of the sensors is displaced, in the case where another modification example of the light separating element based on the technical principle of the embodiment is used.

FIGS. 21A through 21F are diagrams for describing an output signal from each sensor when the position of the sensors is displaced, in the case where another modification example of the light separating element based on the technical principle of the embodiment is used.

FIGS. 22A through 22C are diagrams showing an optical system of an optical pickup device in Example 1.

FIGS. 23A and 23B are diagrams showing an arrangement of a light separating element in Example 1.

FIG. 24 is a diagram showing a sensor layout of a photodetector in Example 1.

FIGS. 25A through 25C are schematic diagrams showing irradiation areas in Examples 1 and 2.

FIGS. 26A through 26D are diagrams showing simulation results on the irradiation area in Example 1.

FIGS. 27A and 27B are diagrams showing an arrangement of a light separating element in Example 2.

FIG. 28 is a diagram showing a circuit configuration for suppressing an offset (a DC component) of a push-pull signal in Example 2.

FIGS. 29A and 29B are diagrams for describing a change in a signal resulting from lens shift based on the technical principle of the embodiment.

FIGS. 30A through 30D are diagrams showing simulation results on the irradiation area in Example 2.

The drawings are provided mainly for describing the present invention, and do not limit the scope of the present invention.

### DESCRIPTION OF PREFERRED EMBODIMENTS

In the following, an embodiment of the invention is described referring to the drawings.

### Technical Principle

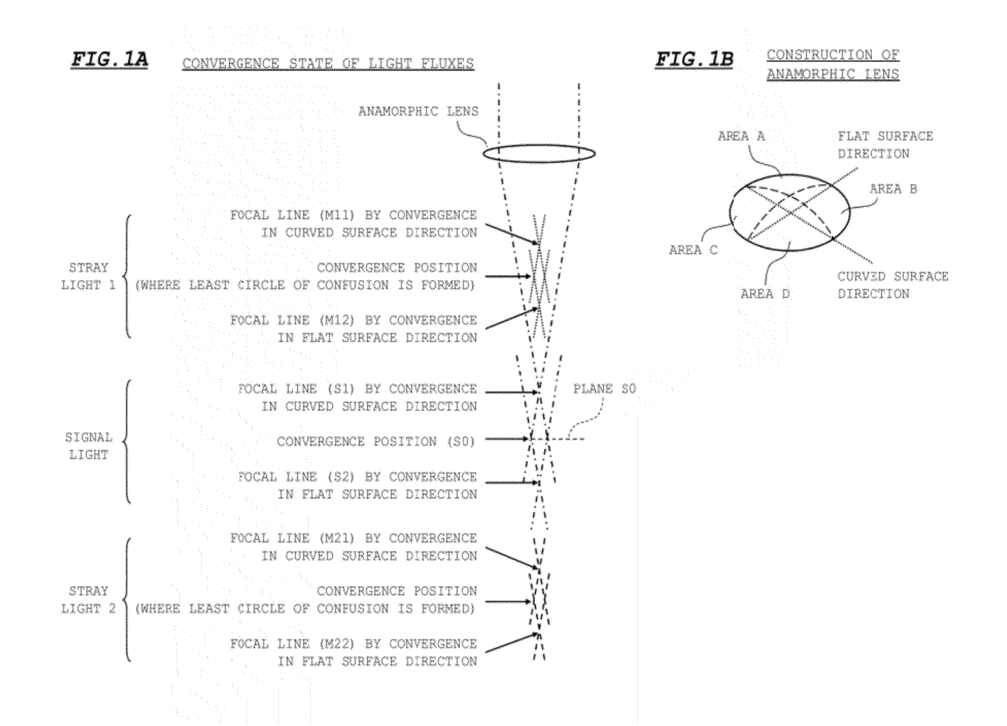

First, a technical principle to which the embodiment of the invention is applied is described referring to FIGS. 1A through 6.

FIGS. 1A and 1B are diagrams showing a state as to how light rays are converged. FIG. 1A is a diagram showing a state as to how laser light (signal light) reflected on a target recording layer, laser light (stray light 1) reflected on a layer located at a rearward position with respect to the target recording layer, and laser light (stray light 2) reflected on a layer located at a forward position with respect to the target recording layer are converged. FIG. 1B is a diagram showing an arrangement of an anamorphic lens to be used in the technical principle.

Referring to FIG. 1B, the anamorphic lens has a function of converging laser light to be entered in a direction in parallel to the lens optical axis, in a curved surface direction and a flat surface direction. The curved surface direction and the flat surface direction intersect perpendicularly to each other. Further, the curved surface direction has a smaller radius of curvature than that of the flat surface direction, and has a greater effect of converging laser light to be entered into the anamorphic lens.

To simplify the description on the astigmatism function of the anamorphic lens, the terms “curved surface direction” and “flat surface direction” are used. Actually, however, as far as the anamorphic lens has a function of forming focal lines at different positions from each other, the shape of the anamorphic lens in the “flat surface direction” in FIG. 1B is not limited to a flat plane shape. In the case where laser light is entered into the anamorphic lens in a convergence state, the shape of the anamorphic lens in the “flat surface direction” may be a straight line shape (where the radius of curvature=∞).

Referring to FIG. 1A, signal light converged by the anamorphic lens forms focal lines at different positions from each other by convergence in the curved surface direction and in the flat surface direction. The focal line position (S1) of signal light by convergence in the curved surface direction is close to the anamorphic lens than the focal line position (S2) of signal light by convergence in the flat surface direction, and the convergence position (S0) of signal light is an intermediate position between the focal line positions (S1) and (S2) by convergence in the curved surface direction and in the flat surface direction.

Similarly to the above, the focal line position (M11) of stray light 1 converged by the anamorphic lens by convergence in the curved surface direction is close to the anamorphic lens than the focal line position (M12) of stray light 1 by convergence in the flat surface direction. The anamorphic lens is designed to make the focal line position (M12) of stray light 1 by convergence in the flat surface direction close to the anamorphic lens than the focal line position (51) of signal light by convergence in the curved surface direction.

Similarly to the above, the focal line position (M21) of stray light 2 converged by the anamorphic lens in the curved surface direction is close to the anamorphic lens than the focal line position (M22) of stray light 2 by convergence in the flat surface direction. The anamorphic lens is designed to make the focal line position (M21) of stray light 2 by convergence in the curved surface direction away from the anamorphic lens than the focal line position (S2) of signal light by convergence in the flat surface direction.

Further, the beam spot of signal light has a shape of a least circle of confusion on the convergence position (S0) between the focal line position (S1) and the focal line position (S2).

Taking into account the above matters, the following is a description about a relationship between irradiation areas of signal light and stray light 1, 2 on the plane S0.

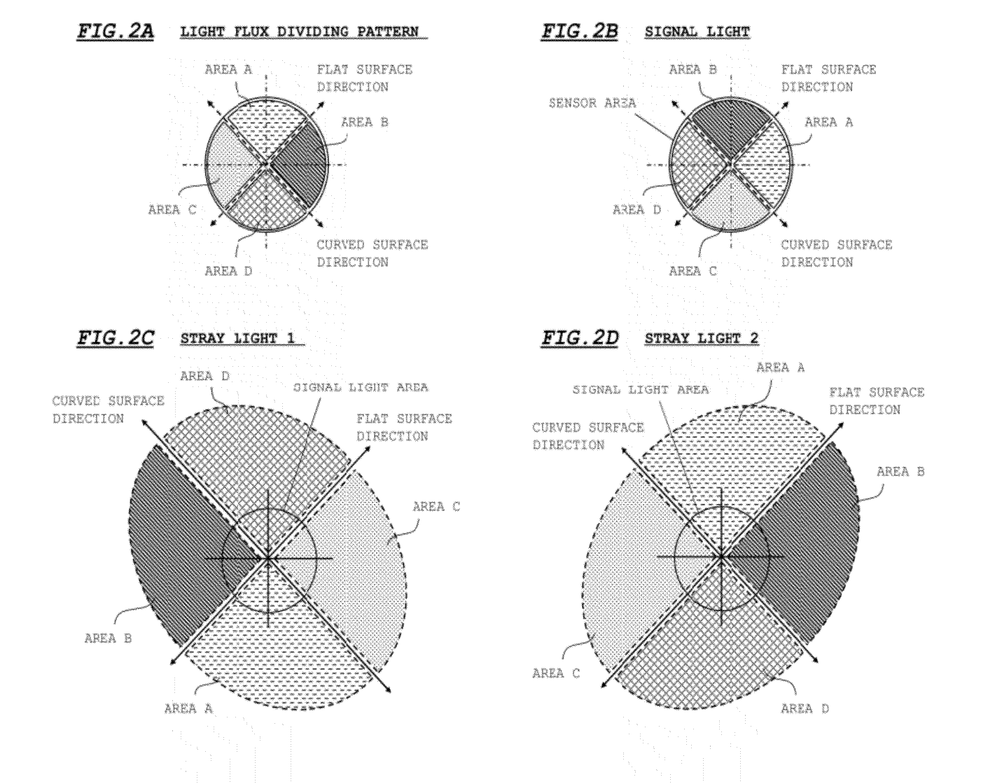

As shown in FIG. 2A, the anamorphic lens is divided into four areas A through D. In this case, signal light entered into the areas A through D is distributed on the plane S0, as shown in FIG. 2B. Further, stray light 1 entered into the areas A through D is distributed on the plane S0, as shown in FIG. 2C, and stray light 2 entered into the areas A through D is distributed on the plane S0, as shown in FIG. 2D.

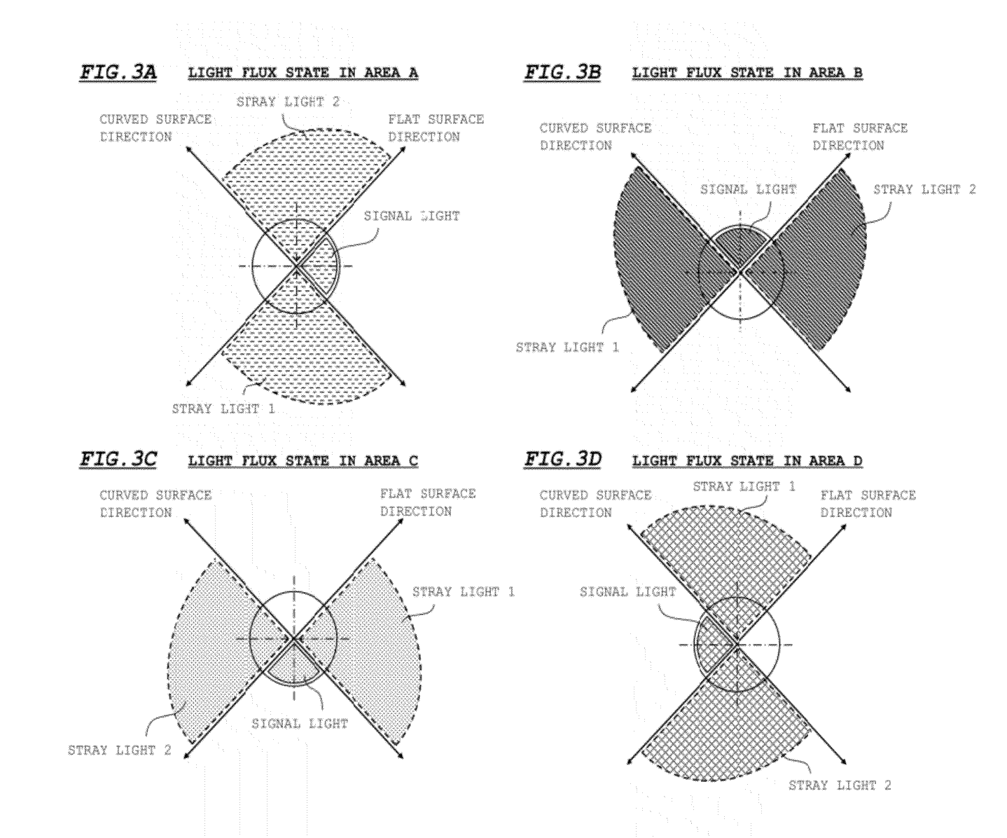

If signal light and stray light 1, 2 on the plane S0 are extracted in each of light flux areas, the distributions of the respective light are as shown in FIGS. 3A through 3D. In this case, stray light 1 and stray light 2 in the same light flux area are not overlapped with signal light in each of the light flux areas. Accordingly, if the device is configured such that only signal light is received by a sensor after light fluxes (signal light, stray light 1, 2) in each of the light flux areas are separated in different directions, only signal light is entered into a corresponding sensor to thereby suppress incidence of stray light. Thus, it is possible to avoid degradation of a detection signal resulting from stray light.

As described above, it is possible to extract only signal light by dispersing and separating light passing through the areas A through D from each other on the plane S0. The embodiment is made based on the above technical principle.

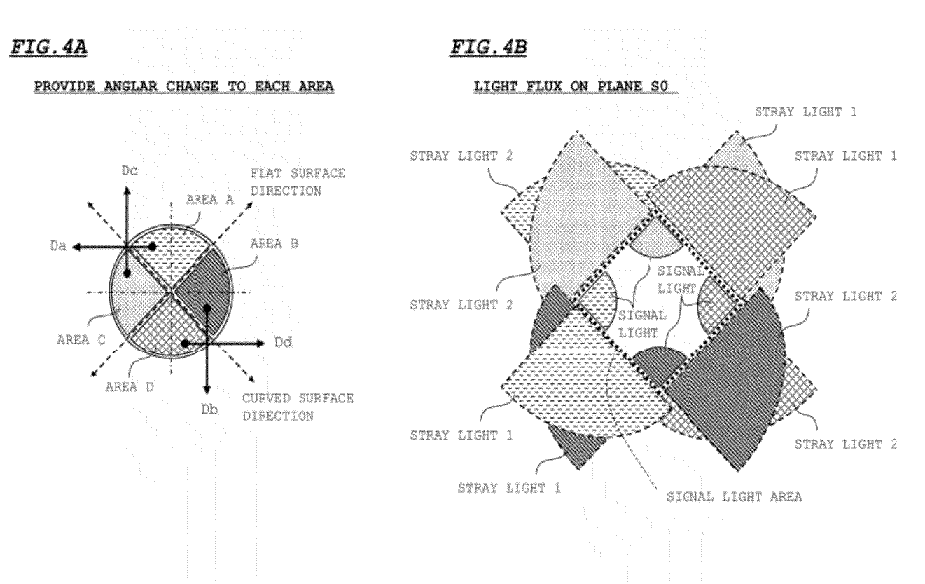

FIGS. 4A and 4B are diagrams showing a distribution state of signal light and stray light 1, 2 on the plane S0, in the case where the propagating directions of light fluxes (signal light, stray light 1, 2) passing through the four areas A through D shown in FIG. 2A are respectively changed in different directions by the same angle. FIG. 4A is a diagram of the anamorphic lens when viewed from the optical axis direction of the anamorphic lens (the propagating direction along which laser light is entered into the anamorphic lens), and FIG. 4B is a diagram showing a distribution state of signal light, stray light 1, 2 on the plane S0.

In FIG. 4A, the propagating directions of light fluxes (signal light, stray light 1, 2) that have passed through the areas A through D are respectively changed into directions Da, Db, Dc, Dd by the same angle amount α (not shown) with respect to the propagating directions of the respective light fluxes before incidence. The directions Da, Db, Dc, Dd each has an inclination of 45° with respect to the flat surface direction and the curved surface direction.

In this case, as shown in FIG. 4B, it is possible to distribute signal light and stray light 1, 2 in each of the light flux areas, on the plane S0, by adjusting the angle amount α with respect to the directions Da, Db, Dc, Dd. As a result of the above operation, as shown in FIG. 4B, it is possible to form a signal light area where only signal light exists on the plane S0. By disposing sensors of a photodetector in the signal light area, it is possible to receive only signal light in each of the light flux areas by a corresponding sensor.

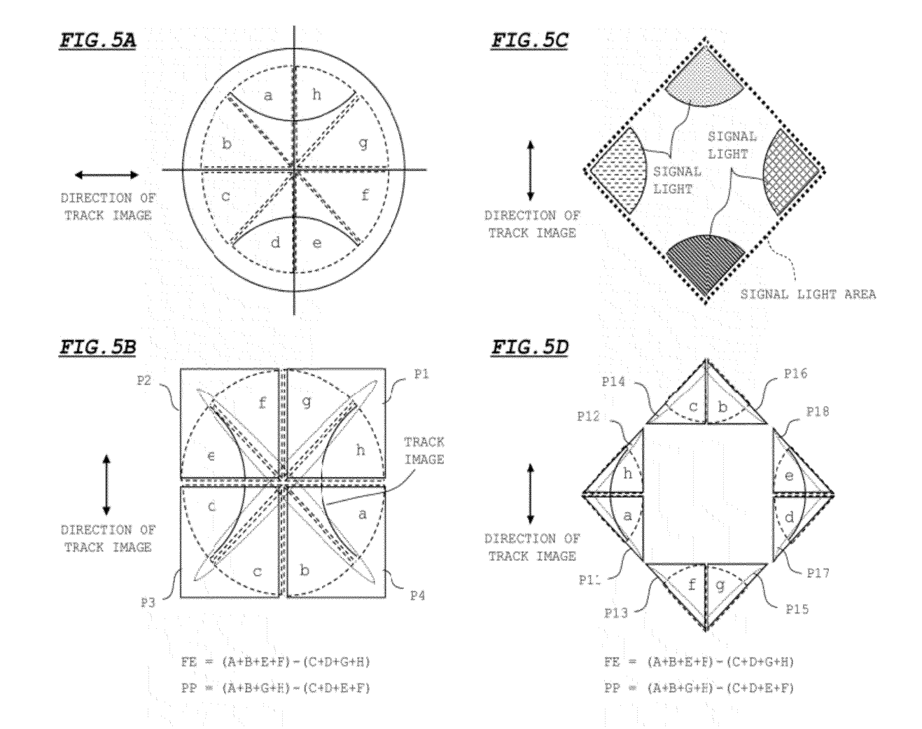

FIGS. 5A through 5D are diagrams showing a method for arranging sensors. FIG. 5A is a diagram showing light flux areas of reflected light (signal light) on a disc, and FIG. 5B is a diagram showing a distribution state of signal light on a photodetector, in the case where an anamorphic lens and a photodetector (a four-divided sensor) based on a conventional astigmatism method are respectively disposed on the arranged position of the anamorphic lens and on the plane S0, in the arrangement shown in FIG. 1A. FIGS. 5C and 5D are diagrams showing a distribution state of signal light and a sensor layout based on the above principle, on the plane S0.

The direction of a diffraction image (a track image) of signal light resulting from a track groove has an inclination of 45° with respect to the flat surface direction and the curved surface direction. In FIG. 5A, assuming that the direction of a track image is aligned with leftward and rightward directions, in FIGS. 5B through 5D, the direction of a track image by signal light is aligned in upward and downward directions. In FIGS. 5A, 5B and 5D, to simplify the description, a light flux is divided into eight light flux areas a through h. Further, the track image is shown by the solid line, and the beam shape in an out-of-focus state is shown by the dotted line.

It is known that an overlapped state of a zero-th order diffraction image and a first-order diffraction image of signal light resulting from a track groove is obtained by an equation: wavelength/(track pitch×objective lens NA). As shown in FIGS. 5A, 5B, 5D, a requirement that a first-order diffraction image is formed in the four light flux areas a, b, e, h is expressed by: wavelength track pitch×objective lens NA>√2.

In the conventional astigmatism method, sensors P1 through P4 (a four-divided sensor) of a photodetector are arranged as shown in FIG. 5B. In this case, assuming that detection signal components based on light intensities in the light flux areas a through h are expressed by A through H, a focus error signal FE and a push-pull signal PP are obtained by the following equations (1) and (2).

FE=(A+B+E+F)−(C+D+G+H) (1)

PP=(A+B+G+H)−(C+D+E+F) (2)

On the other hand, as described above, signal light is distributed in the signal light area as shown in FIG. 5C in the distribution state shown in FIG. 4B. In this case, signal light passing through the light flux areas a through h shown in FIG. 5A is distributed as shown in FIG. 5D. Specifically, signal light passing through the light flux areas a through h in FIG. 5A are guided to the light flux areas a through h shown in FIG. 5D, on the plane S0 where the sensors of the photodetector are disposed.

Accordingly, by disposing the sensors P11 through P18 at the positions of the light flux areas a through h shown in FIG. 5D in an overlapped state as shown in FIG. 5D, it is possible to generate a focus error signal and a push-pull signal by performing the same computation as applied to the process described in the case of FIG. 5B. Specifically, assuming that A through H represent detection signals from the sensors for receiving light fluxes in the light flux areas a through h, a focus error signal FE and a push-pull signal PP can be acquired by the above equations (1) and (2) in the same manner as described in the case of FIG. 5B.

As described above, according to the above principle, it is possible to generate a focus error signal and a push-pull signal (a tracking error signal) with no or less influence of stray light by performing the same computation as applied to the process based on the conventional astigmatism method.

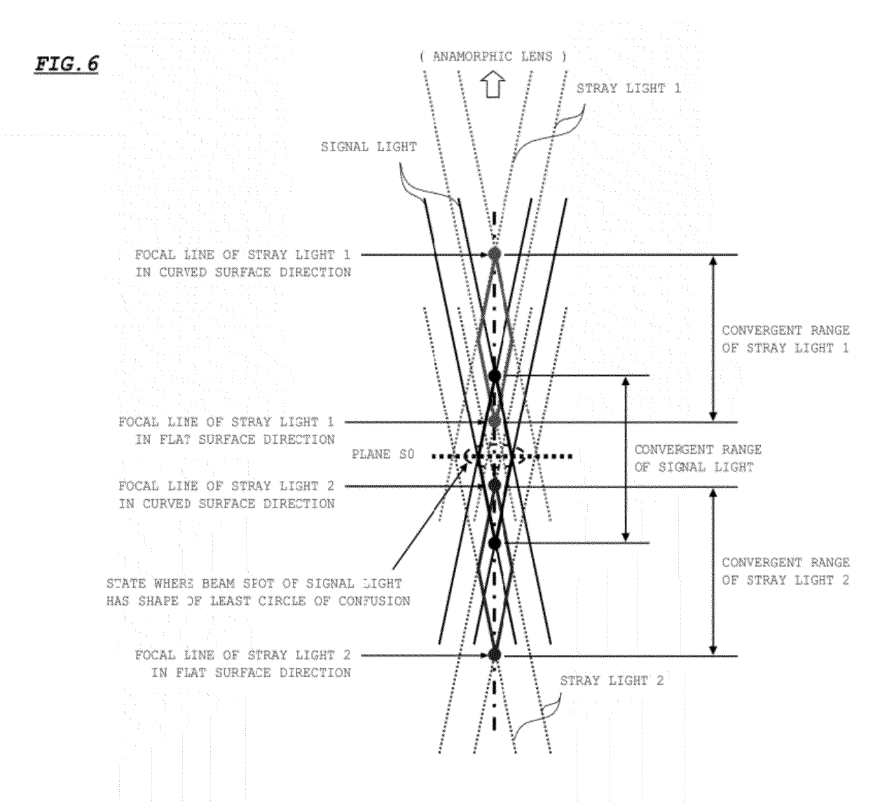

The effect by the above principle is obtained, as shown in FIG. 6, in the case where the focal line position of stray light 1 in the flat surface direction is close to the anamorphic lens with respect to the plane S0 (a plane where the beam spot of signal light has a shape of a least circle of confusion), and the focal line position of stray light 2 in the curved surface direction is away from the anamorphic lens with respect to the plane S0. Specifically, as far as the above relationship is satisfied, the distribution state of signal light, and stray light 1, 2 is as shown in FIG. 4B, which makes it possible to keep signal light, and stray light 1, 2 from overlapping each other on the plane S0. In other words, as far as the above relationship is satisfied, the advantage based on the above principle is obtained, even if the focal line position of stray light 1 in the flat surface direction comes closer to the plane S0 than the focal line position of signal light in the curved surface direction, or even if the focal line position of stray light 2 in the curved surface direction comes closer to the plane S0 than the focal line position of signal light in the flat surface direction.

### Light Separating Element H0

A light separating element H0 may be used to distribute signal light passing through the eight light flux areas a through h shown in FIG. 5A on the sensor layout shown in FIG. 5D.

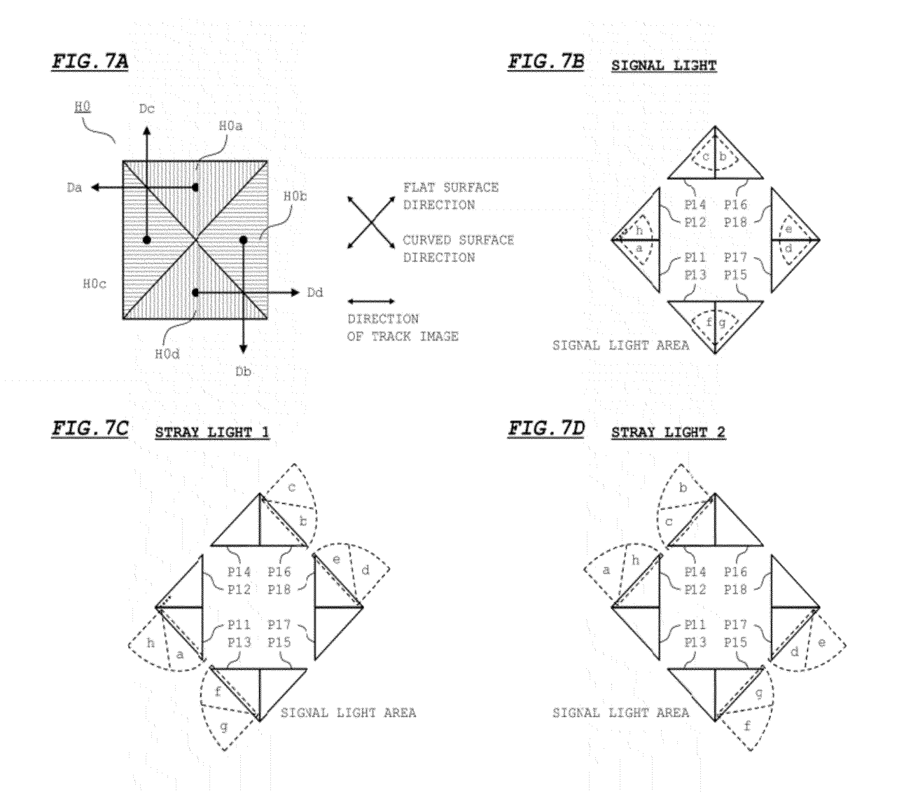

FIG. 7A is a diagram showing an arrangement of the light separating element H0. FIG. 7A is a plan view of the light separating element H0 when viewed from the side of the anamorphic lens shown in FIG. 1A, 1B. FIG. 7A also shows the flat surface direction, the curved surface direction of the anamorphic lens shown in FIG. 1B, and the direction of a track image of laser light to be entered into the light separating element H0.

The light separating element H0 is made of a square transparent plate, and has a diffraction pattern (a diffraction hologram) on a light incident surface thereof. As shown in FIG. 7A, the light incident surface of the light separating element H0 is divided into four diffraction areas H0a through H0d. The light separating element H0 is disposed at such a position that laser light passing through the light flux areas A through D shown in FIG. 4A are respectively entered into the diffraction areas H0a through H0d. The diffraction areas H0a through H0d respectively diffract the entered laser light in the directions Da through Dd shown in FIG. 4A by the same angle by diffraction on the diffraction areas H0a through H0d.

FIGS. 7B through 7D are schematic diagrams showing irradiation areas, in the case where laser light passing through the eight light flux areas a through h shown in FIG. 5A is irradiated onto the sensor layout shown in FIG. 5D. FIG. 7B is a diagram showing a state as to how signal light is irradiated onto the sensors P11 through P18, in the case where the focus position of laser light is adjusted on a target recording layer. FIGS. 7C, 7D are diagrams showing states of stray light 1 and stray light 2 in the above condition. To simplify the description, the irradiation areas of laser light passing through the light flux areas a through h are indicated as irradiation areas a through h in each of the drawings of FIGS. 7B through 7D.

As shown in FIG. 7B, signal light is irradiated onto the sensors P11 through P18 based on the above principle. The sensors P11 through P18 are configured such that the irradiation area of signal light is sufficiently included in each of the sensors P11 through P18. Specifically, as shown in FIG. 7B, the sensor layout is configured in such a manner that four vertices of the signal light area are positioned on the inside of four vertices on the outside of the sensor layout.

As shown in FIG. 7C, stray light 1 is irradiated onto a position adjacent to the outside of the signal light area according to the above principle. As described above, however, if the sensor layout is configured in such a manner that the signal light area is positioned on the inside of the sensor layout, the irradiation area of stray light 1 is likely to overlap the sensors P11 through P18. Similarly to the above, as shown in FIG. 7D, the irradiation area of stray light 2 is also likely to overlap the sensors P11 through P18.

As described above, in the case where signal light passing through the light flux areas a through h is distributed on the sensor layout, using the light separating element H0, stray light 1, 2 is likely to be irradiated onto the sensors P11 through P18, which may degrade the precision of output signals from the sensors P11 through P18.

Next, described is an arrangement as to how a recording layer is discriminated using the light separating element H0.

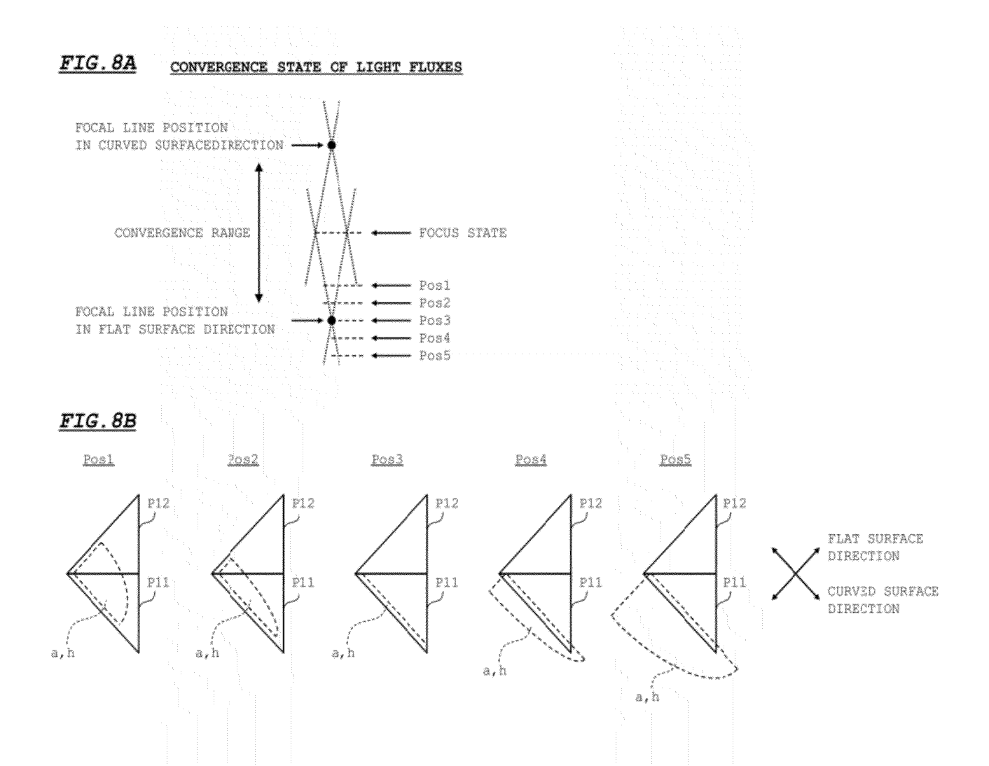

FIG. 8A is a diagram showing a state as to how reflected light from a certain recording layer in a disc is converged. FIG. 8B is a schematic diagram showing the irradiation areas a, h, in the case where a light receiving surface (sensors P11 through P18) of a photodetector is positioned at the positions Pos1 through Pos5, with respect to the convergence range shown in FIG. 8A.

As shown in FIG. 8B, in the case where the light receiving surface lies within the convergence range (Pos1, Pos2), the irradiation areas a, h are positioned within the area of the sensors P11 and P12. In the case where the light receiving surface is out of the convergence range (Pos4, Pos5), as shown in FIG. 7C, the irradiation areas a, h are positioned on the outside of the sensors P11 and P12. In the case where the light receiving surface is near the focal line position in the flat surface direction (Pos2, Pos4), the irradiation areas a, h have a configuration with a long size in the curved surface direction and a short size in the flat surface direction. In the case where the light receiving surface is at the focal line position in the flat surface direction (Pos3), the irradiation areas a, h have a linear shape extending in the curved surface direction.

In the above arrangement, the sum of output signals from the sensors P11 and P12 in the case where the light receiving surface is out of the convergence range is smaller than the sum of output signals from the sensors P11 and P12 in the case where the light receiving surface lies within the convergence range. However, as shown by Pos4, Pos5 in FIG. 8B, since the irradiation areas a, h positioned on the outside of the sensors P11 and P12 are near the sensors P11 and P12, a part of the irradiation areas a, h is overlapped with the sensors P11 and P12. As a result, even if the light receiving surface is shifted away from the convergence range, a part of the irradiation areas a, h continues to be overlapped with the sensors P11 and P12, which makes it difficult to make the sum of output signals from the sensors P11 and P12 closer to zero.

Similarly to the above, in the case where the light receiving surface is shifted away from the convergence range, it is also difficult to make the sum of output signals from the sensors P13 and P15, the sensors P14 and P16, the sensors P17 and 18 closer to zero. Accordingly, in the case where the light receiving surface is shifted away from the convergence range, it is difficult to make the sum (a SUM signal) of output signals from the sensors P11 through P18 closer to zero.

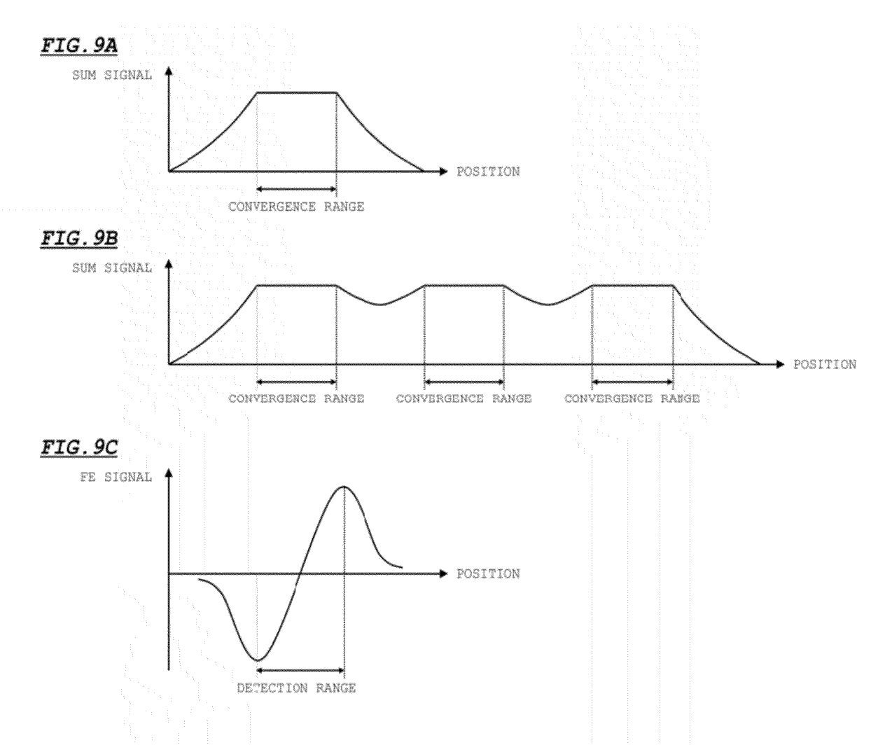

FIG. 9A is a schematic diagram showing a SUM signal, in the case where the position of the light receiving surface (sensors P11 through P18) of the photodetector is shifted from the convergence range of reflected light on a certain recording layer in a disc.

Referring to FIG. 9A, in the case where the light receiving surface lies within the convergence range, the irradiation areas a through h are positioned on the sensors P11 through P18, and the SUM signal is substantially kept constant. In the case where the light receiving surface is out of the convergence range, since the irradiation areas a through h are positioned on the outside of the sensors P11 through P18, the SUM signal to be obtained when the light receiving surface is out of the convergence range is smaller than the SUM signal to be obtained when the light receiving surface lies within the convergence range. As described above, in the case where the light receiving surface is shifted away from the convergence range, it is difficult to make the SUM signal closer to zero. As a result, as shown in FIG. 9A, the SUM signal to be obtained when the light receiving surface is out of the convergence range has a moderate slope.

FIG. 9B is a schematic diagram showing a state that the convergence ranges of plural recording layers are adjacent to each other, and that the SUM signal shown in FIG. 9A is overlapped.

In the case where a disc has plural recording layers, a target recording layer is discriminated by a fall of a SUM signal between the adjacent convergence ranges shown in FIG. 9B. In this arrangement, as shown in FIG. 9A, since the SUM signal to be obtained when the light receiving surface is out of the convergence range has a moderate slope, a fall of an overlapped SUM signal as shown in FIG. 9B is also small. As a result, it may be difficult to discriminate a target recording layer.

Next, an S-shaped curve in the case where the light separating element H0 is used is described. The S-shaped curve represents a configuration of a focus error signal FE expressed by the equation (1), in the case where the focus position of laser light is shifted forward and rearward of a recording layer. A detection range of the S-shaped curve corresponds to a width by which the focus position of laser light is shifted between the case where the S-shaped curve has a maximum value and the case where the S-shaped curve has a minimum value.

Referring back to FIG. 8B, in the case where the light receiving surface of the photodetector is shifted from Pos1 to Pos3, the output signal from the sensor P11 as a plus component of a focus error signal FE is increased, and the output signal from the sensor P12 as a minus component of the focus error signal FE is decreased. Further, in the case where the light receiving surface of the photodetector is shifted from Pos3 to Pos5, the irradiation area is positioned on the outside of the sensors P11 and P12, and the irradiation area is continued to expand. As a result, the output signal from the sensor P11 as a plus component of a focus error signal FE is decreased. Thus, it is clear that the value obtained by subtracting the output signal of the sensor P12 from the output signal of the sensor P11 is maximum, in the case where the light receiving surface is in the vicinity of Pos3.

Similarly to the above, in the case where the light receiving surface is near the focal line position in the curved surface direction, a value obtained by subtracting an output signal of the sensor P12 from an output signal of the sensor P11 becomes minimal. The same description as described above is also applied to output signals from the sensors P13 and P15, the sensors P16 and P14, the sensors P18 and P17. Thus, a peak of an S-shaped curve is formed on the plus side of a focus error signal FE in the case where the light receiving surface is near the focal line position in the flat surface direction, and a peak of the S-shaped curve is formed on the minus side of the focus error signal FE in the case where the light receiving surface is at the focal line position in the curved surface direction.

Further, in the case where the light receiving surface is shifted away from the convergence range, a part of the irradiation areas a, h continues to overlap the sensors. As a result, it is difficult to make output signals from the sensors P11, P13, P16, P18, as a plus component of a focus error signal FE, closer to zero, as well as the SUM signal. Thus, it is difficult to make the focus error signal FE closer to zero in a range outside of the detection range of an S-shaped curve.

FIG. 9C is a diagram showing an S-shaped curve, in the case where the focus position of laser light is shifted forward and rearward of a recording layer.

As described above, in the case where the light receiving surface of the photodetector is positioned at the focal line position in the flat surface direction and in the curved surface direction, a peak of an S-shaped curve is formed. Further, as described above, in the case where the light receiving surface is shifted away from the convergence range, it is difficult to make the focus error signal FE closer to zero in a range outside of the detection range. As a result, as shown in FIG. 9C, the focus error signal FE has a moderate slope in a range outside of the detection range.

In the case where plural recording layers are formed in proximity to each other, left and right portions of the S-shaped curve shown in FIG. 9C are overlapped with S-shaped curves of recording layers adjacent to a target recording layer. As a result, in performing focus servo control with respect to the target recording layer, the target S-shaped curve for focus control may be distorted resulting from an influence of the left-side or right-side S-shaped curve. It is necessary to narrow the detection range shown in FIG. 9C, and to make the slope of the focus error signal FE sharp in a range outside of the detection range in order to reduce the influence of the left-side or right-side S-shaped curve which may overlap the target S-shaped curve for focus control.

As described above, in the case where the light separating element H0 shown in FIG. 7A is used, a SUM signal and a focus error signal FE (an S-shaped curve) may be degraded. In view of this, the inventor of the present application has conceived alight separating element H1, which is an improved modification of the light separating element H0.

### Light Separating Element H1

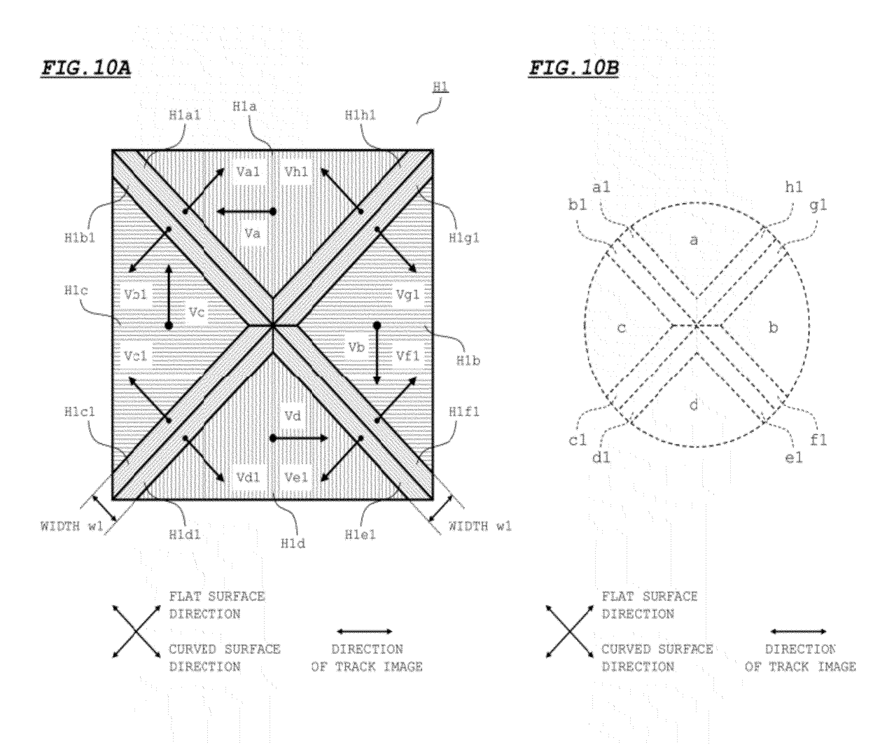

FIG. 10A is a diagram showing an arrangement of the light separating element H1. FIG. 10A is a plan view of the light separating element H1 when viewed from an incident surface thereof. FIG. 10B is a diagram showing twelve light flux areas a through d, a1 through h1 of laser light to be entered into the light separating element H1, which are illustrated in correlation with borderlines between diffraction areas of the light separating element H1. FIG. 10A, 10B also show the flat surface direction, the curved surface direction of the anamorphic lens shown in FIG. 1B, and the direction of a track image of laser light to be entered into the light separating element H1.

Referring to FIG. 10A, the light incident surface of the light separating element H1 is divided into diffraction areas H1a through H1d, H1a1 through H1h1. As shown in FIG. 10A, the diffraction areas H1a1 and H1b1, and the diffraction areas H1e1 and H1f1 extend in the curved surface direction, and have a width w1. As shown in FIG. 10A, the diffraction areas H1c1 and H1d1, and the diffraction areas H1g1 and H1h1 extend in the flat surface direction, and have a width w1. Further, the light separating element H1 is disposed in such a manner that the center of the light separating element H1 is aligned with an optical axis of laser light, and the light flux areas a through d, a1 through h1 shown in FIG. 10B are respectively entered into the light flux areas H1a through H1d, H1a1 through H1h1.

The diffraction areas H1a through H1d, H1a1 through H1h1 respectively diffract the entered laser light into directions Va through Vd, Va1 through Vh1 by diffraction on the diffraction areas H1a through H1d, H1a1 through H1h1. The directions Va through Vd coincide with the directions Da through Dd shown in FIG. 4A, respectively. The directions Va1, Vb1, Ve1, Vf1 are directions in parallel to the flat surface direction, and the directions Vc1, Vd1, Vg1, Vh1 are directions in parallel to the curved surface direction. Further, as shown in FIG. 10A, the directions Va1, Vb1, the directions Vc1, Vd1, the directions Ve1, Vf1, the directions Vg1, Vh1 are oriented in opposite directions to each other by 180 degrees, respectively.

In this embodiment, the pitch of the diffraction pattern on the diffraction areas H1a1 through H1h1 is set smaller than the pitch of the diffraction pattern on the diffraction areas H1a through H1d. With this arrangement, the diffraction angle of laser light diffracted on the diffraction areas H1a1 through H1h1 is set larger than the diffraction angle of laser light diffracted on the diffraction areas H1a through H1d.

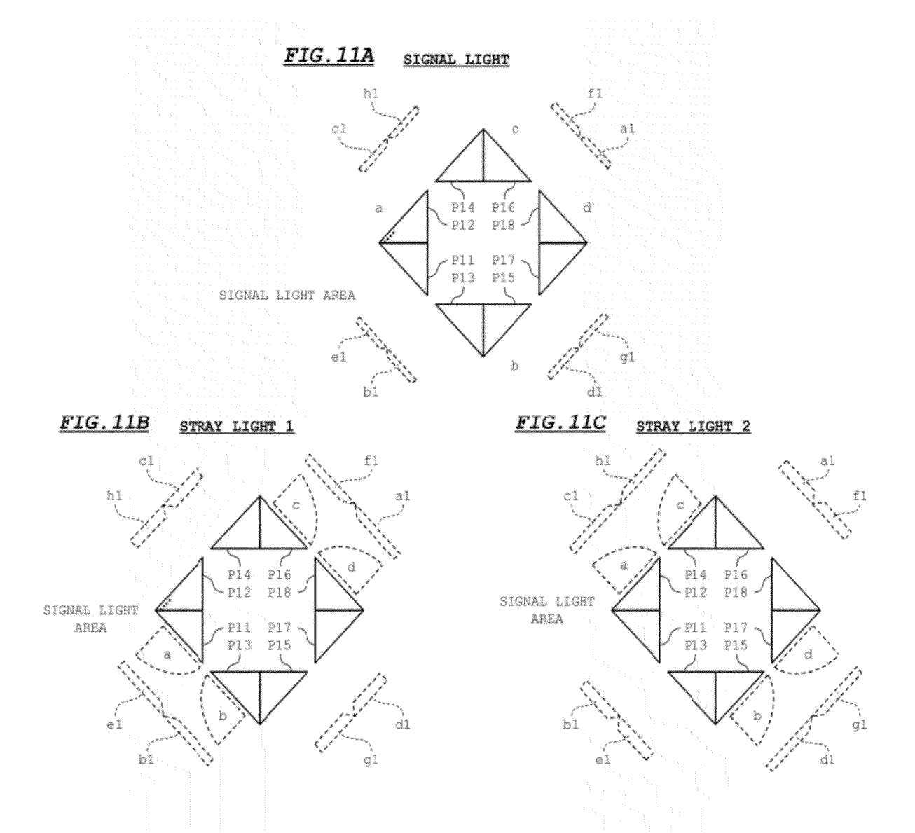

FIGS. 11A through 11C are schematic diagrams showing irradiation areas, in the case where laser light passing through the light flux areas a through d, a1 through h1 shown in FIG. 10B is irradiated onto the sensors P11 through P18 by the light separating element H1 shown in FIG. 10A. FIGS. 11A through 11C are diagrams respectively showing signal light, and stray light 1, 2 of laser light to be irradiated onto the sensors P11 through P18, in the case where the focus position of laser light is adjusted on a target recording layer.

As shown in FIG. 11A, signal light of laser light passing through the light flux areas a through d is irradiated onto the sensors P11 through P18, and signal light of laser light passing through the light flux areas a1 through h1 is irradiated to a position away from the signal light area. In other words, only signal light of laser light to be entered into the diffraction areas H1a through H1d, of signal light of laser light to be entered into the light separating element H1, is irradiated onto the sensors P11 through P18. In the above arrangement, the irradiation areas on the sensors P11 through P18 are positioned on the inside of the signal light area in accordance with the width w1 (see FIG. 10A) of the diffraction areas H1a1 through H1h1.

As shown in FIG. 11B, 11C, stray light 1, 2 of laser light passing through the light flux areas a through d, a1 through h1 is irradiated to a position on the outside of the signal light area. In this arrangement, stray light 1, 2 of laser light passing through the light flux areas a through d is irradiated to a position more outwardly of the signal light area, as compared with the case (see FIG. 7C, 7D) where the light separating element H0 is used. With this arrangement, there is no or less likelihood that stray light 1, 2 may be entered into the sensors P11 through P18.

Next, described is an arrangement as to how a recording layer is discriminated using the light separating element H1.

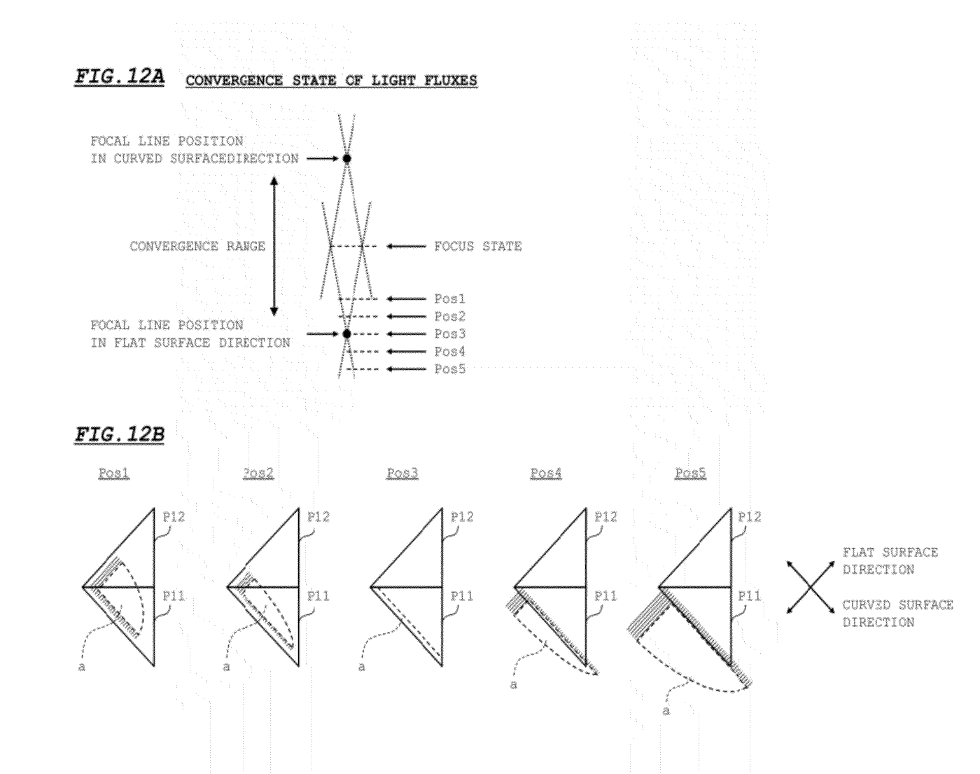

FIG. 12A is a diagram showing a state as to how laser light reflected on a certain recording layer in a disc is converged. FIG. 12B is a schematic diagram showing an irradiation area a, in the case where the sensors P11 through P18 of the photodetector are positioned at the positions Pos1 through Pos5 with respect to the convergence range shown in FIG. 12A. The hatched portions on the vertex portions of the irradiation areas a shown in FIG. 12B indicate areas where signal light is removed by the diffraction areas H1a1, H1h1 of the light separating element H1. Specifically, in the case where the light separating element H0 is used in place of the light separating element H1, laser light passing through the light flux area a is irradiated onto an area formed by adding the hatched portion to the broken-line portion.

As shown in FIG. 12B, in the case where the light receiving surface lies within the convergence range (Pos1, Pos2), the irradiation area a is positioned within the area of the sensors P11 and P12. In the case where the light receiving surface is out of the convergence range (Pos4, Pos5), as shown in FIG. 11B, the irradiation area a is positioned on the outside of the sensors P11 and P12. In the case where the light receiving surface is near the focal line position in the flat surface direction (Pos2, Pos4), the irradiation area a has a configuration with a long size in the curved surface direction and a short size in the flat surface direction. In the case where the light receiving surface is at the focal line position in the flat surface direction (Pos3), the irradiation area a has a linear shape extending in the curved surface direction.

In the above arrangement, the sum of output signals from the sensors P11 and P12 in the case where the light receiving surface lies on the outside of the convergence range is smaller than the sum of output signals from the sensors P11 and P12 in the case where the light receiving surface lies on the inside of the convergence range. Further, as shown by Pos4, Pos5 in FIG. 12B, the width of a light blocking portion in the flat surface direction is increased, as the light receiving surface is shifted away from the convergence range, and the irradiation area a is shifted away from the sensor P12. As a result, in the case where the light receiving surface is shifted away from the convergence range, as compared with the case where the light separating element H0 is used, the intensity of light to be irradiated onto the sensors P11, P12 is rapidly reduced, which makes it easy to make the sum of output signals from the sensors P11, P12 closer to zero.

Similarly to the above, in the case where the light receiving surface is shifted away from the convergence range, the above arrangement also makes it easy to make the sum of output signals from the sensors P13 and P15, the sensors P14 and P16, the sensors P17 and 18 closer to zero. Accordingly, in the case where the light receiving surface is shifted away from the convergence range, it is easy to make the sum (a SUM signal) of output signals from the sensors P11 through P18 closer to zero.

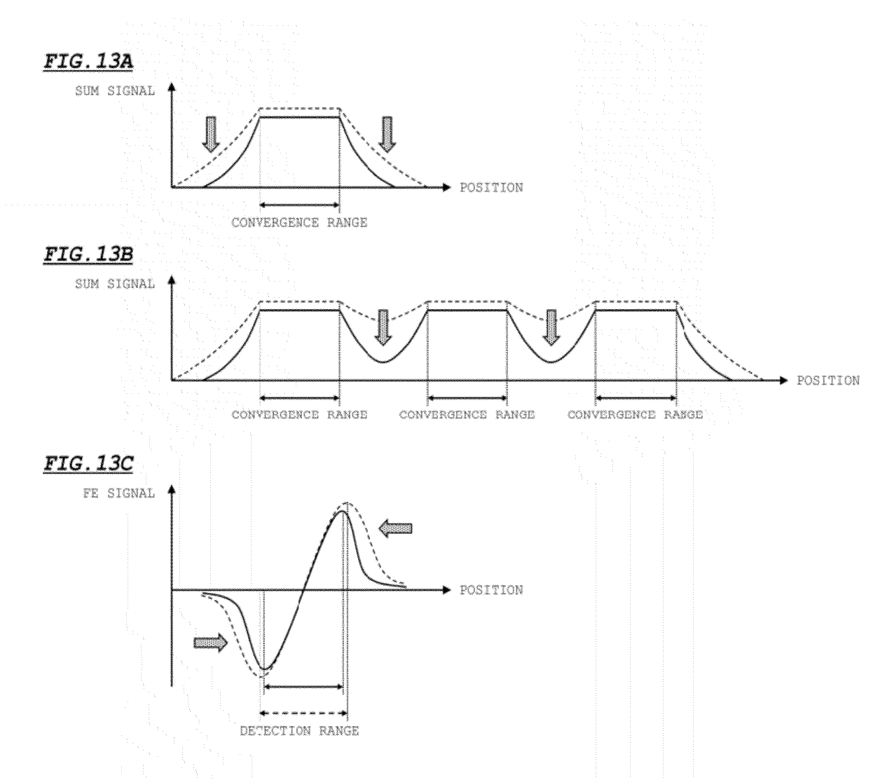

FIG. 13A is a schematic diagram showing a SUM signal, in the case where the position of the light receiving surface (sensors P11 through P18) of the photodetector is shifted from the convergence range of reflected light on a certain recording layer in a disc. The broken line in FIG. 13A shows a schematic diagram of a SUM signal, in the case where the light separating element H0 is used.

Referring to FIG. 13A, in the case where the light receiving surface lies within the convergence range, the irradiation areas a through d are positioned on the sensors P11 through P18, and the SUM signal is kept substantially constant. In the case where the light receiving surface lies on the outside of the convergence range, since the irradiation areas a through d are positioned on the outside of the sensors P11 through P18, the SUM signal to be obtained when the light receiving surface lies on the outside of the convergence range is smaller than the SUM signal to be obtained when the light receiving surface lies within the convergence range. The SUM signal to be obtained in the above case is reduced in accordance with the light amount of light to be separated and irradiated to a position on the outside of the sensors P11 through P18 by the diffraction areas H1a1 through H1h1, as compared with the SUM signal (indicated by the broken line) to be obtained in the case where the light separating element H0 is used.

As described above, in the case where the light receiving surface is shifted away from the convergence range, it is easy to make the SUM signal closer to zero. Accordingly, as shown in FIG. 13A, the SUM signal to be obtained in the case where the light receiving surface lies on the outside of the convergence range has a sharp slope, as compared with the case where the light separating element H0 is used.

FIG. 13B is a schematic diagram showing a state that the convergence ranges of plural recording layers are close to each other, and the SUM signal shown in FIG. 13A is overlapped. As shown in FIG. 13A, the SUM signal to be obtained in the case where the light receiving surface lies on the outside of the convergence range has a sharp slope. Accordingly, a fall of an overlapped SUM signal as shown in FIG. 13B is large, as compared with the case where the light separating element H0 is used. Thus, the above arrangement makes it easy to discriminate a recording layer.

Next, an S-shaped curve in the case where the light separating element H1 is used is described.

Referring back to FIG. 12B, in the case where the light receiving surface of the photodetector is shifted from Pos1 to Pos3, the output signal from the sensor P11 as a plus component of a focus error signal FE is increased, and the output signal from the sensor P12 as a minus component of the focus error signal FE is decreased. In this case, since the width of the light blocking portion in the curved surface direction is increased, the irradiation area on the sensor P12 is more rapidly decreased, as compared with the case where the light separating element H0 is used. As a result, a value obtained by subtracting an output signal of the sensor P12 from an output signal of the sensor P11 is gradually increased, and becomes maximal before the light receiving surface reaches Pos3. Further, in the case where the light receiving surface of the photodetector is shifted from Pos3 to Pos4, the output signal from the sensor P11 as a plus component of a focus error signal FE is more rapidly decreased, as compared with the case where the light separating element H0 is used. As a result, a value obtained by subtracting an output signal of the sensor P12 from an output signal of the sensor P11 comes closer to zero more quickly, as the light receiving surface is shifted away from Pos3.

Similarly to the above, in the case where the light receiving surface is shifted from the center of the convergence range toward the focal line position in the curved surface direction, a value obtained by subtracting an output signal of the sensor P12 from an output signal of the sensor P11 becomes minimal before the light receiving surface reaches the focal line position in the flat surface direction; and after the light receiving surface passes the focal line position in the flat surface direction, a value obtained by subtracting an output signal of the sensor P12 from an output signal of the sensor P11 comes closer to zero more quickly. The same description as described above is also applied to the sensors P13 and P15, the sensors P16 and P14, and the sensors P18 and P17.

As described above, in the case where the light receiving surface is on the side of the center of the convergence range than the focal line position in the flat surface direction and the focal line position in the curved surface direction, a peak of an S-shaped curve is formed. Further, it is easy to make the focus error signal FE closer to zero in a range outside of the detection range of the S-shaped curve.

FIG. 13C is a diagram showing an S-shaped curve, in the case where the focus position of laser light is shifted forward and rearward of a recording layer.

As described above, in the case where the light receiving surface of the photodetector is positioned on the side of the center of the convergence range than the focal line position in the flat surface direction and the focal line position in the curved surface direction, a peak of an S-shaped curve is formed. Further, as described above, in the case where the light receiving surface is shifted away from the convergence range, it is easy to make the focus error signal FE closer to zero in a range outside of the detection range. Accordingly, as shown in FIG. 13C, the focus error signal FE has a sharp slope in a range outside of the detection range.

In the case where plural recording layers are formed in proximity to each other, left and right portions of the S-shaped curve shown in FIG. 13C are overlapped with S-shaped curves of recording layers adjacent to a target recording layer. In this case, as compared with the case where the light separating element H0 is used, the detection range is narrow, and the focus error signal FE has a sharp slope in a range outside of the detection range. The above arrangement makes it easy to isolate the target S-shaped curve; and in performing focus servo control with respect to a target recording layer, the target S-shaped curve for focus control is less likely to be distorted resulting from an influence of the left-side or right-side S-shaped curve.

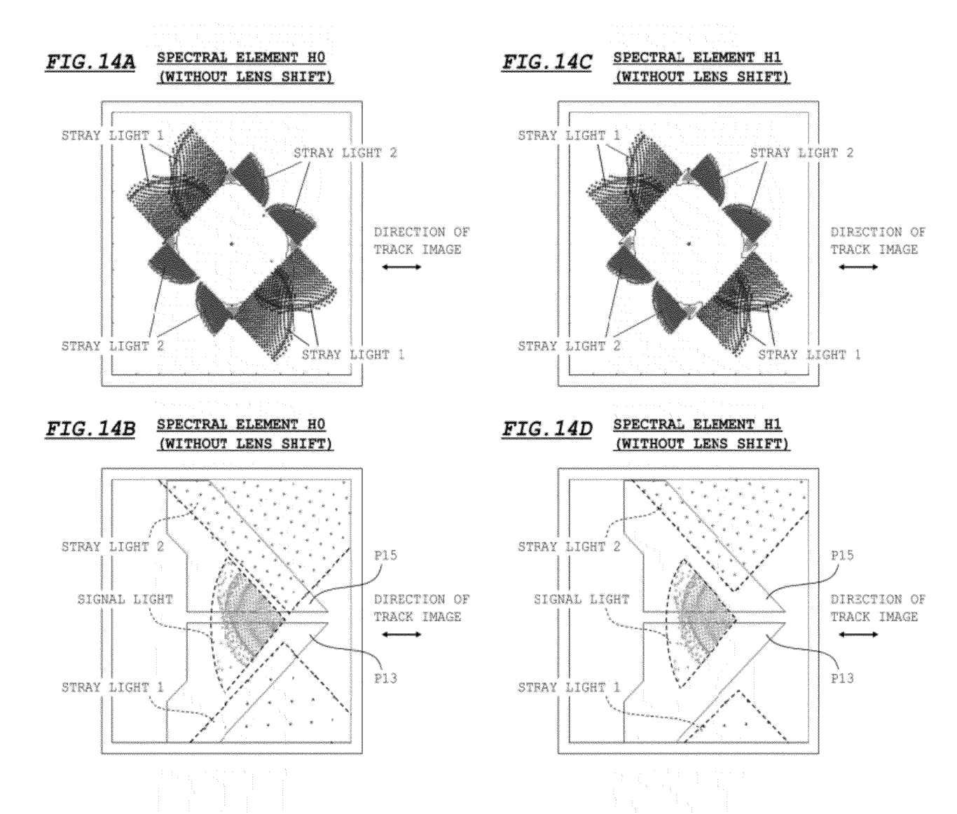

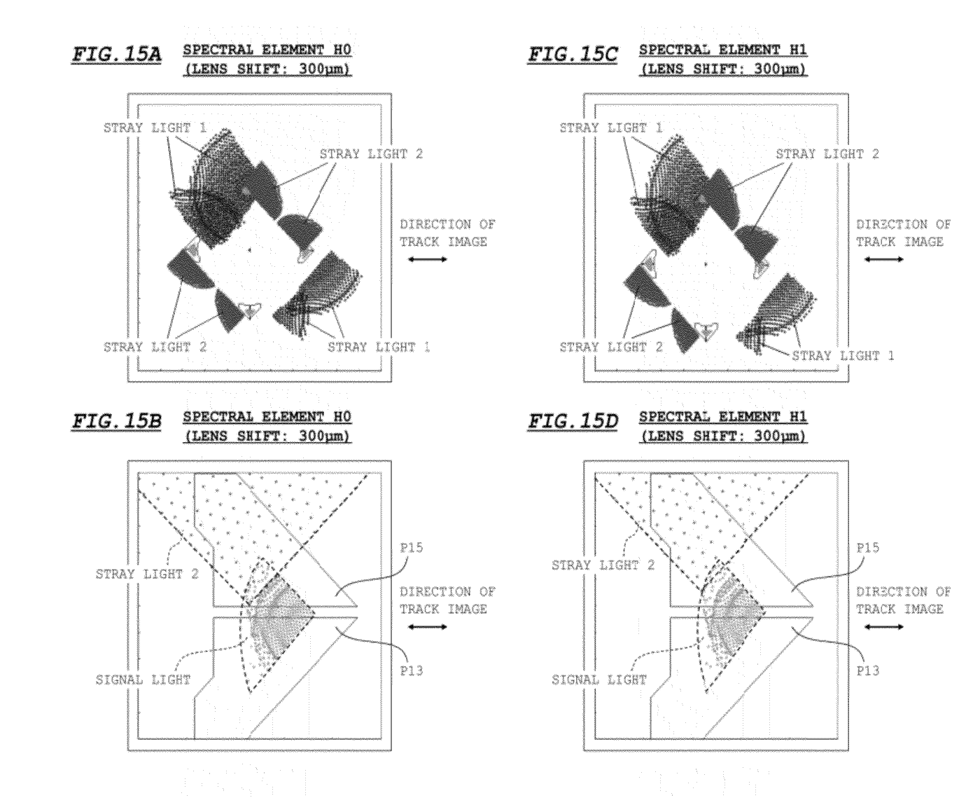

FIGS. 14A through 14D and FIGS. 15A through 15D are diagrams showing simulation results of an irradiation area on the sensor layout, in the case where the light separating element H0 is used, and in the case where the light separating element H1 is used. In the above simulation, the width w1 of the light separating element H1 is set to 5% of the diameter of laser light to be entered into the light separating element H1. Further, the above simulation is made based on the premise that the objective lens is not shifted in FIGS. 14A through 14D, and that the objective lens is shifted by 300 μm in FIGS. 15A through 15D.

As shown in FIGS. 14A and 14B, FIGS. 15A and 15B, in the case where the light separating element H0 is used, the irradiation area of stray light comes close to the irradiation area of signal light. As a result, stray light is likely to be irradiated onto the sensors P11 through P18. In contrast, as shown in FIGS. 14C and 14D, FIGS. 15C and 15D, in the case where the light separating element H1 is used, there is no or less likelihood that stray light may be irradiated onto the sensors P11 through P18, because the irradiation area of signal light and the irradiation area of stray light are formed away from each other by diffraction on the diffraction areas H1a1 through H1h1 shown in FIG. 10A, as compared with the case where the light separating element H0 is used.

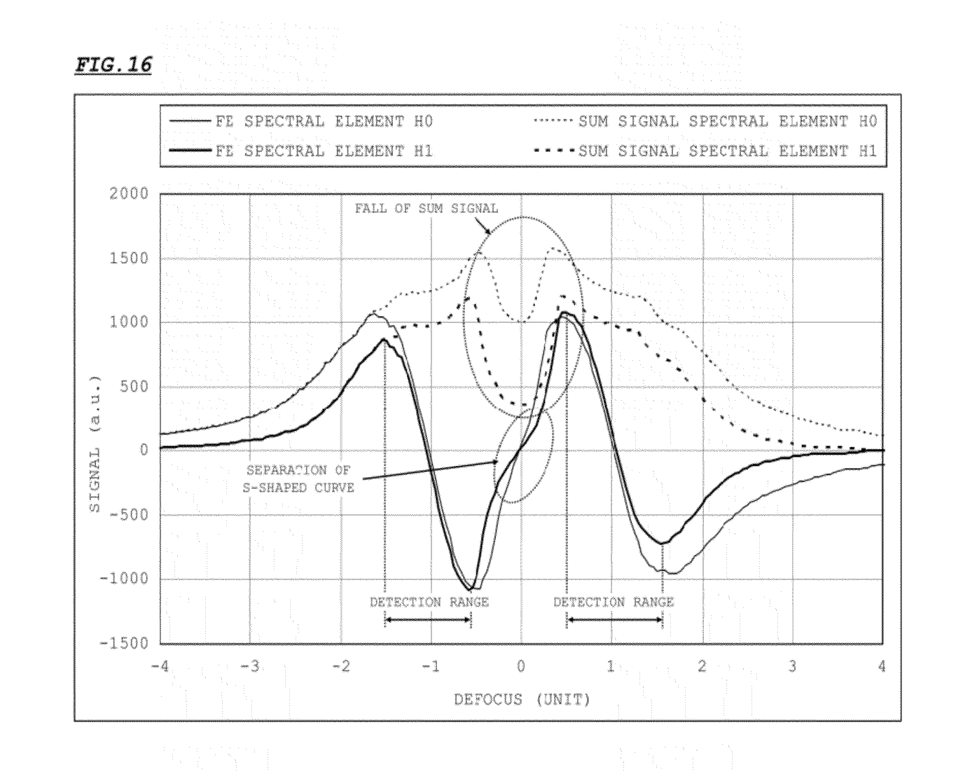

FIG. 16 is a diagram showing a simulation result on a value of a focus error signal FE, and a sum (a SUM Signal) of output signals from the sensors P11 through P18. In the above simulation, the refractive index of a region between recording layers in a disc is set to 1.6. The horizontal axis in FIG. 16 indicates a value in accordance with a moving amount of an objective lens.

In the case where the light separating element H1 is used, as shown in FIG. 16, as compared with the case where the light separating element H0 is used, a fall of a SUM signal between adjacent recording layers is large, and the detection range of each S-shaped curve is narrow. Further, in the case where the light separating element H1 is used, as described above, since there is no or less likelihood that S-shaped curves of adjacent recording layers may affect the target S-shaped curve, the focus error signal FE comes closer to zero more quickly, and has a sharp slope in the target S-shaped curve. Thus, the above arrangement makes it easy to isolate the target S-shaped curve.

### Positional Displacement of Sensors

Next, described is an output signal from each sensor when the positions of the sensors P11 through P18 are displaced, in the case where the light separating element H0 is used.

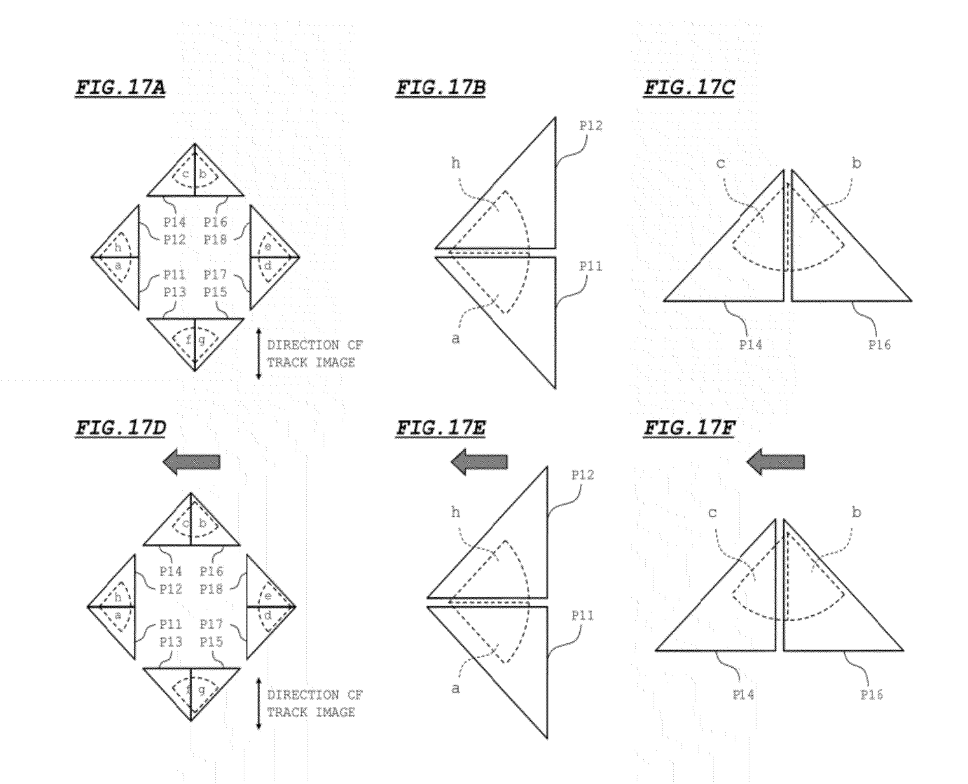

FIG. 17A is a diagram showing an irradiation area of signal light passing through the light flux areas a through h shown in FIG. 5A, in the case where the positions of the sensors P11 through P18 are not displaced. The irradiation areas of laser light passing through the light flux areas a through h, on the plane S0, are indicated as irradiation areas a through h to simplify the description. FIG. 17A shows a state that the focus position of laser light is adjusted on a target recording layer. As shown in FIG. 17A, in this case, signal light passing through the light flux areas a through h is uniformly irradiated onto each of the sensors.

FIGS. 17B, 17C are enlarged views showing an irradiation area near the sensors P11, P12, and an irradiation area near the sensors P14, P16 in the state shown in FIG. 17A. As shown in FIGS. 8B, 8C, a slight clearance is formed between the sensors P11, P12, and between the sensors P14, P16. Likewise, a slight clearance is formed between the sensors P13, P15, and between the sensors P17, P18.

As shown in FIG. 17B, although an upper end of the irradiation area a and a lower end of the irradiation area h are respectively deviated from the sensors P11, P12, light passing through the irradiation areas a, h are respectively and uniformly entered into the sensors P11, P12. As shown in FIG. 17C, although a left end of the irradiation area b and a right end of the irradiation area c are respectively deviated from the sensors P16, P14, the irradiation areas b, c respectively and uniformly overlap the sensors P16, P14. Likewise, the irradiation areas f, g respectively and uniformly overlap the sensors P13, P15, and the irradiation areas d, e respectively and uniformly overlap the sensors P17, P18.

FIG. 17D is a diagram showing irradiation areas of signal light passing through the light flux areas a through h, in the case where the positions of the sensors P11 through P18 are displaced from the state shown in FIG. 17A in a direction (leftward or rightward direction) perpendicular to the direction of a track image. As shown in FIG. 17D, although the irradiation areas are the same as those in the state shown in FIG. 17A, since the positions of the sensors P11 through P18 are displaced leftward, the irradiation areas in the state shown in FIG. 17D are displaced rightward within the sensors P11 through P18.

FIG. 17E is an enlarged view showing irradiation areas near the sensors P11, P12 in the state shown in FIG. 17D. As shown in FIG. 17E, the irradiation areas a, h respectively and uniformly overlap the sensors P11, P12 in the same manner as the state shown in FIG. 17B, although the irradiation areas a, h are respectively displaced rightward from the sensors P11, P12. Accordingly, the output signals from the sensors P11, P12 in the state shown in FIG. 17E are substantially the same as the output signals from the sensors P11, P12 in the state shown in FIG. 17A. Likewise, the output signals from the sensors P17, P18 in the state shown in FIG. 17E are substantially the same as the output signals from the sensors P17, P18 in the state shown in FIG. 17A.

FIG. 17F is an enlarged view showing irradiation areas near the sensors P14, P16 in the state shown in FIG. 17D. As shown in FIG. 17F, although a right end of the irradiation area b lies within the sensor P16, a left end of the irradiation area b overlaps the sensor P16, unlike the state shown in FIG. 17C. Further, although a left end of the irradiation area c lies within the sensor P14, a right end of the irradiation area c is deviated rightward from the sensor P14 and overlaps the sensor P16, unlike the state shown in FIG. 17C. As a result, the output signal from the sensor P16 is increased, and the output signal from the sensor P14 is decreased, as compared with the state shown in FIG. 17A. Likewise, the output signal from the sensor P15 is increased, and the output signal from the sensor P13 is decreased, as compared with the state shown in FIG. 17A.

Further, in the case where the positions of the sensors P11 through P18 are displaced rightward substantially by the same displacement amount as the state shown in FIG. 17D, the output signals from the sensors P11, P12, P17, P18 are kept substantially unchanged, the output signals from the sensors P13, P14 are increased, and the output signals from the sensors P15, P16 are decreased, as compared with the state shown in FIG. 17A. Further, in the case where the positions of the sensors P11 through P18 are displaced in a direction (upward or downward direction) in parallel to the direction of a track image substantially by the same displacement amount as the state shown in FIG. 17D, the output signals from the sensors P13 through P16 are kept substantially unchanged, and the output signals from the sensors P11, P12, P17, P18 are changed.

In the above arrangement, it is preferable to keep the output signals from the sensors P11 through P18 unchanged, even if the positions of the sensors P11 through P18 are displaced. However, as described above, if the positions of the sensors P11 through P18 are displaced resulting from e.g. aging deterioration, the output signals from the sensors P11 through P18 are changed depending on a direction of the positional displacement and an amount of the positional displacement. As a result, the precision of output signals from the sensors P11 through P18 may be lowered. In view of the above, the inventor of the present application has conceived a light separating element H2, which is an improved modification of the light separating element H0.

### Light Separating Element H2

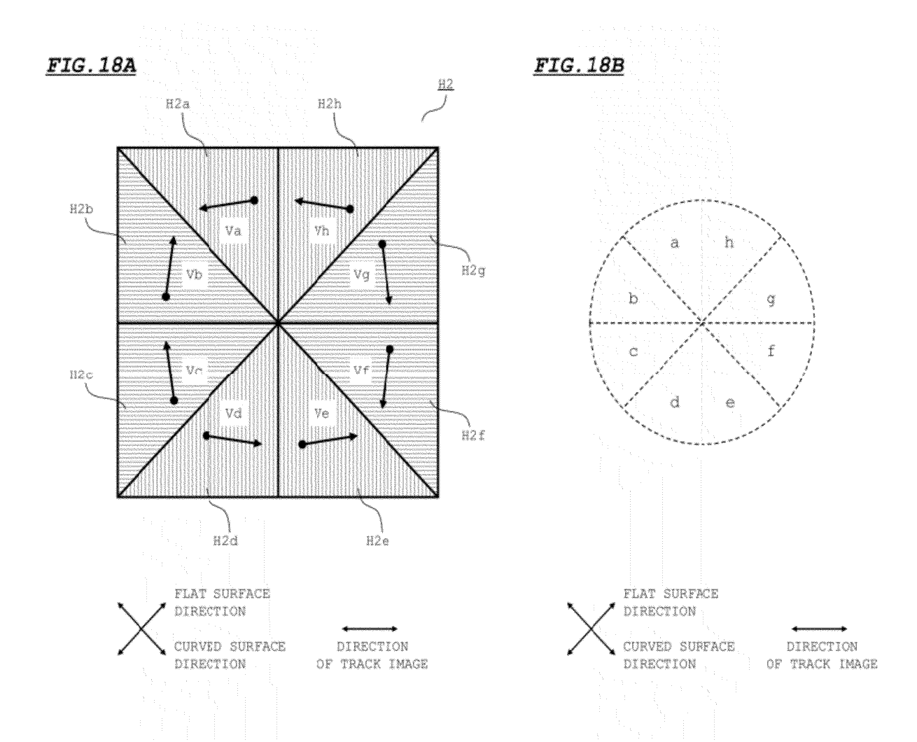

FIG. 18A is a diagram showing an arrangement of the light separating element H2. FIG. 18A is a plan view of the light separating element H2 when viewed from an incident surface thereof. FIG. 18B is a diagram showing eight light flux areas a through h of laser light to be entered into the light separating element H2, which are illustrated in correlation with borderlines between diffraction areas of the light separating element H2. FIGS. 18A, 18B also show the flat surface direction, the curved surface direction of the anamorphic lens shown in FIG. 1B, and the direction of a track image of laser light to be entered into the light separating element H2.

Referring to FIG. 18A, the light incident surface of the light separating element H2 is divided into diffraction areas H2a through H2h. Further, the light separating element H2 is disposed in such a manner that the center of the light separating element H2 is aligned with an optical axis of laser light, and the light flux areas a through h shown in FIG. 18B are respectively entered into the light flux areas H2a through H2h.

The diffraction areas H2a through H2h respectively diffract the entered laser light into directions Va through Vh by diffraction on the diffraction areas H2a through H2h. The directions Va, Vh are respectively and slightly displaced from the direction Da shown in FIG. 4A by a component in downward direction and by a component in upward direction. The directions Vf, Vg are respectively and slightly displaced from the direction Db shown in FIG. 4A by a component in leftward direction and by a component in rightward direction. The directions Vb, Vc are respectively and slightly displaced from the direction Dc shown in FIG. 4A by a component in rightward direction and by a component in leftward direction. The directions Vd, Ve are respectively and slightly displaced from the direction Dd shown in FIG. 4A by a component in downward direction and by a component in upward direction. Further, each of the diffraction areas H2a through H2h diffracts laser light by the same diffraction angle by plus first order diffraction function. The diffraction angle is adjusted by the pitch of a diffraction pattern.

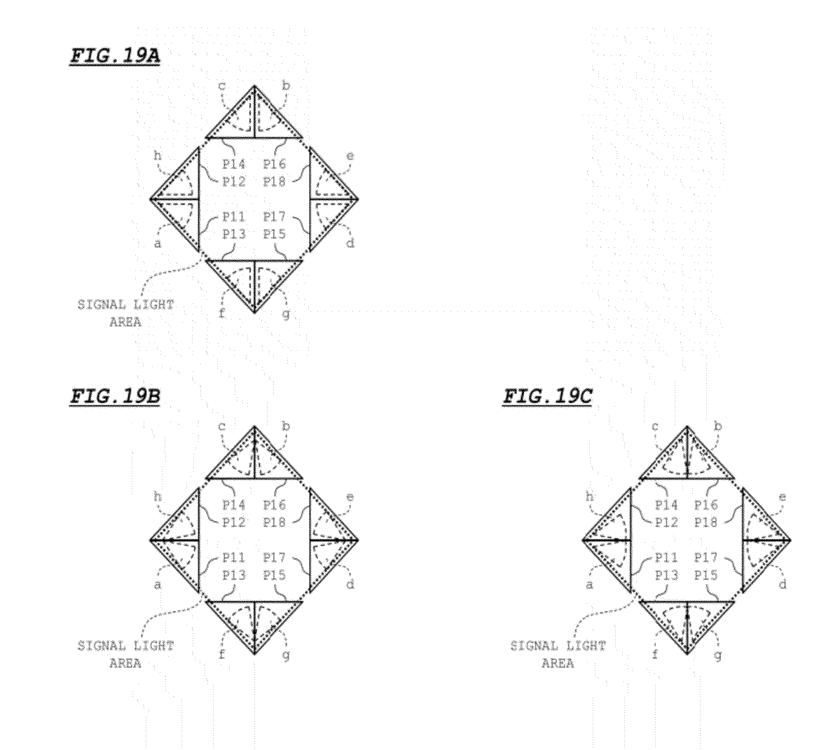

FIG. 19A is a schematic diagram showing an irradiation area, in the case where laser light passing through the light flux areas a through h shown in FIG. 18B is irradiated onto the sensors P11 through P18 by the light separating element H2 shown in FIG. 18A. FIG. 19A is a diagram showing signal light of laser light to be irradiated onto the sensors P11 through P18, in the case where the focus position of laser light is adjusted on a target recording layer.

As shown in FIG. 19A, signal light of laser light passing through the light flux areas a through h is respectively irradiated onto the sensors P11, P16, P14, P17, P18, P13, P15, P12. In this arrangement, stray light 1, 2 of laser light passing through the light flux areas a through h is irradiated to a position on the outside of the signal light area substantially in the same manner as the state shown in FIG. 4B.

Further, the irradiation area a and the irradiation area h are away from each other in up and down directions by a predetermined distance, with a boundary portion between the sensor P11 and the sensor P12 being formed therebetween. The irradiation area b and the irradiation area c are away from each other in left and right directions by a predetermined distance, with a boundary portion between the sensor P16 and the sensor P14 being formed therebetween. The irradiation area d and the irradiation area e are away from each other in up and down directions by a predetermined distance, with a boundary portion between the sensor P17 and the sensor P18 being formed therebetween. The irradiation area f and the irradiation area g are away from each other in left and right directions by a predetermined distance, with a boundary portion between the sensor P13 and the sensor P15 being formed therebetween. These distances are generated by the components in upward and downward directions with respect to the directions Va, Vh; the components in leftward and rightward directions with respect to the directions Vb, Vc; the components in upward and downward directions with respect to the directions Vd, Ve; and the components in leftward and rightward directions with respect to the directions Vf, Vg, which have been described above referring to FIG. 18A.

Next, described is an output signal from each sensor when the positions of the sensors P11 through P18 are displaced, in the case where the light separating element H2 is used.

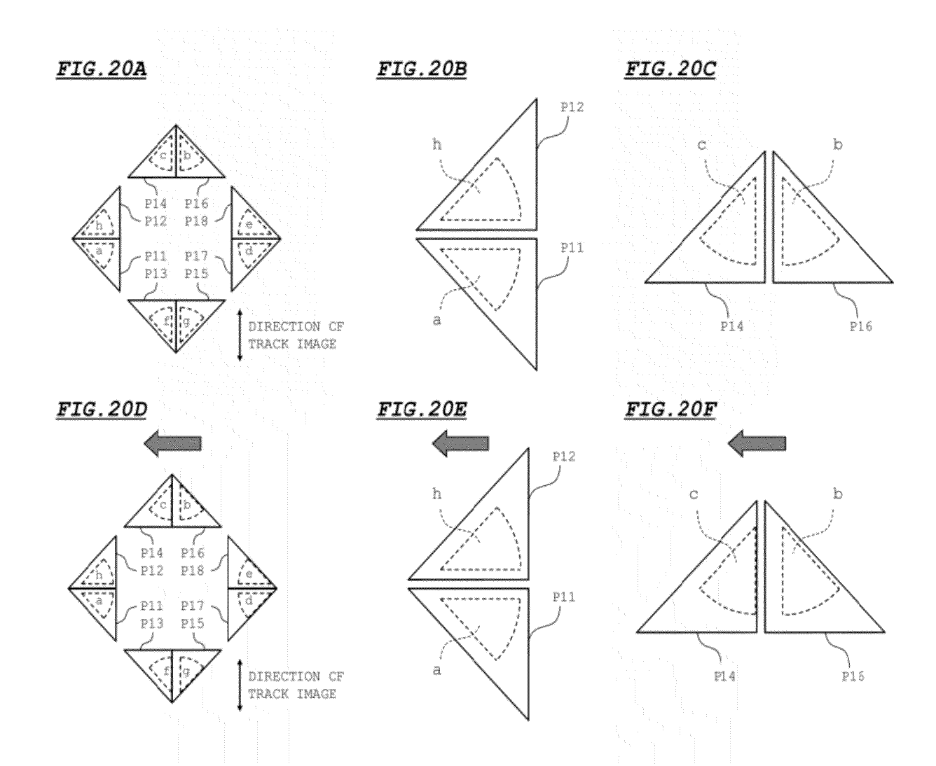

FIG. 20A is a diagram showing an irradiation area of signal light passing through the light flux areas a through h, in the case where the positions of the sensors P11 through P18 are not displaced. FIG. 20A shows a state that the focus position of laser light is adjusted on a target recording layer. As shown in FIG. 20A, in this state, signal light passing through the light flux areas a through h is uniformly irradiated onto each sensor.

FIGS. 20B, 20C are enlarged views showing an irradiation area near the sensors P11, P12, and an irradiation area near the sensors P14, P16 in the state shown in FIG. 20A. As shown in FIG. 20B, the irradiation area a is positioned on the sensor P11, and the irradiation area h is positioned on the sensor P12. The irradiation areas a, h respectively and uniformly overlap the sensors P11, P12. Further, as shown in FIG. 20C, the irradiation area b is positioned on the sensor P16, and the irradiation area c is positioned on the sensor P14. The irradiation areas b, c respectively and uniformly overlap the sensors P16, P14.

Likewise, the irradiation areas f, g are respectively positioned on the sensors P13, P15, and respectively and uniformly overlap the sensors P13, P15. Further, the irradiation areas d, e are respectively shifted downward and upward from the irradiation areas d, e shown in FIG. 7A, and respectively and uniformly overlap the sensors P17, P18.

FIG. 20D is a diagram showing irradiation areas of signal light passing through the light flux areas a through h, in the case where the positions of the sensors P11 through P18 are displaced from the state shown in FIG. 20A in a direction (leftward or rightward direction) perpendicular to the direction of a track image. As shown in FIG. 20D, although the irradiation areas are the same as those in the state shown in FIG. 20A, since the positions of the sensors P11 through P18 are displaced leftward, the irradiation areas in the state shown in FIG. 20D are displaced rightward within the sensors P11 through P18.

FIG. 20E is an enlarged view showing irradiation areas near the sensors P11, P12 in the state shown in FIG. 20D. As shown in FIG. 20E, although the irradiation areas a, h are respectively displaced rightward from the sensors P11, P12, the irradiation areas a, h respectively and uniformly overlap the sensors P11, P12 in the same manner as the state shown in FIG. 20B. Accordingly, the output signals from the sensors P11, P12 in the state shown in FIG. 20E are substantially the same as the output signals from the sensors P11, P12 in the state shown in FIG. 20A. Likewise, the output signals from the sensors P17, P18 in the state shown in FIG. 20E are substantially the same as the output signals from the sensors P17, P18 in the state shown in FIG. 20A.

FIG. 20F is an enlarged view showing irradiation areas near the sensors P14, P16 in the state shown in FIG. 20D. As shown in FIG. 20F, the irradiation area b lies within the sensor P16 in the same manner as the state shown in FIG. 20C. Likewise, the irradiation area c lies within the sensor P14 in the same manner as the state shown in FIG. 20C. Accordingly, the output signals from the sensors P14, P16 in the state shown in FIG. 20F are substantially the same as the output signals from the sensors P14, P16 in the state shown in FIG. 20A. Likewise, the output signals from the sensors P13, P15 in the state shown in FIG. 20F are substantially the same as the output signals from the sensors P13, P15 in the state shown in FIG. 20A.

Further, even in the case where the positions of the sensors P11 through P18 are displaced rightward substantially by the same displacement amount as the state shown in FIG. 20D, the output signals from the sensors P11 through P18 are kept substantially unchanged in the same manner as the states shown in FIGS. 20D through 20F. Further, even in the case where the positions of the sensors P11 through P18 are displaced in a direction (upward or downward direction) in parallel to the direction of a track image substantially by the same displacement amount as the state shown in FIG. 20D, the output signals from the sensors P11 through P18 are also kept substantially unchanged.

As described above, in the case where the light separating element H2 is used, even in the case where the positions of the sensors P11 through P18 are displaced, the output signals from the sensors P11 through P18 are substantially kept unchanged, as compared with a state before displacement occurs. In order to obtain the above advantage, it is desirable to set the clearance between the two irradiation areas positioned at four vertex portions of the signal light area larger than the clearance between the two sensors corresponding to the two irradiation areas, as shown in FIGS. 20B, 20C, 20E, 20F. The clearance between the two irradiation areas is adjusted, as necessary, by adjusting the directions Va through Vh shown in FIG. 18A.

Use of the light separating element H2 is advantageous even in the case where a positional displacement amount of the sensors P11 through P18 is larger than the positional displacement amount shown in FIG. 20D, and the signal light area to be formed by signal light of laser light is deviated from a rectangle defined by the vertices on the outside of the sensor layout. Specifically, with use of the light separating element H2, even in the case where positional displacement of the sensors P11 through P18 is large, the amount by which each of the irradiation areas is deviated from a corresponding sensor, and the amount by which each of the irradiation areas overlaps a sensor adjacent to the corresponding sensor are decreased, as compared with the case where the light separating element H0 is used. Thus, it is possible to keep the precision of output signals from the sensors P11 through P18 high, as compared with the case where the light separating element H0 is used.

In the above arrangement, the light separating element H2 may be provided with a lens function. Specifically, the phase function representing the diffraction function of the diffraction areas H2a through H2h of the light separating element H2 may be provided with a square term. With the modification, as shown in FIG. 19B, for instance, it is possible to set ends of the two irradiation areas positioned at the four vertices of the signal light area, which are on the near side of the corresponding vertex of the signal light area, closer to each other.

In the following, described is an output signal from each sensor when the positions of the sensors P11 through P18 are displaced, in the case where the light separating element H2 has a lens function.

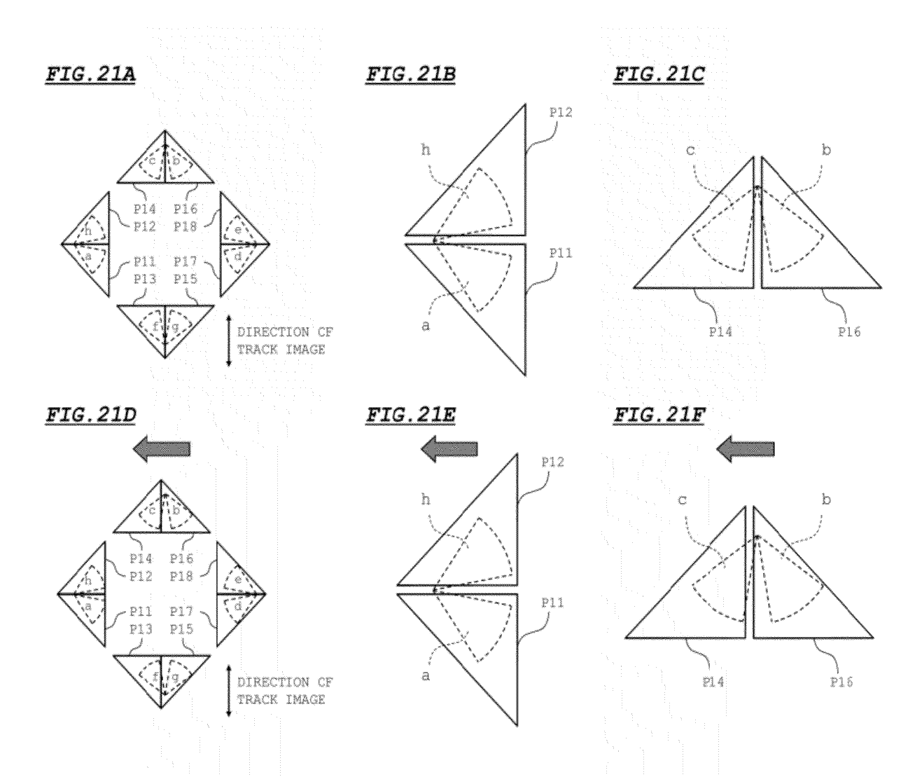

FIG. 21A is a diagram showing an irradiation area of signal light passing through the light flux areas a through h, in the case where the positions of the sensors P11 through P18 are not displaced. FIG. 21A shows a state that the focus position of laser light is adjusted on a target recording layer. In this state, as shown in FIG. 21A, signal light passing through the light flux areas a through h is uniformly irradiated onto each sensor.

FIGS. 21B, 21C are enlarged views respectively showing an irradiation area near the sensors P11, P12, and an irradiation area near the sensors P14, P16 in the state shown in FIG. 21A. Similarly to the above, in this case, the irradiation areas a, h respectively and uniformly overlap the sensors P11, P12, and the irradiation areas b, c respectively and uniformly overlap the sensors P16, P14. Likewise, the irradiation areas f, g respectively and uniformly overlap the sensors P13, P15, and the irradiation areas d, e respectively and uniformly overlap the sensors P17, P18.

FIG. 21D is a diagram showing irradiation areas of signal light passing through the light flux areas a through h, in the case where the positions of the sensors P11 through P18 are displaced from the state shown in FIG. 20A in a direction (leftward or rightward direction) perpendicular to the direction of a track image.

FIG. 21E is an enlarged view showing irradiation areas near the sensors P11, P12 in the state shown in FIG. 21D. As shown in FIG. 21E, although the irradiation areas a, h are respectively shifted rightward from the sensors P11, P12, the irradiation areas a, h respectively and uniformly overlap the sensors P11, P12 in the same manner as the state shown in FIG. 21B. Accordingly, the output signals from the sensors P11, P12 in the state shown in FIG. 21E are substantially the same as the output signals from the sensors P11, P12 in the state shown in FIG. 21A. Likewise, the output signals from the sensors P17, P18 in the state shown in FIG. 21E are substantially the same as the output signals from the sensors P17, P18 in the state shown in FIG. 21A.

FIG. 21F is an enlarged view showing irradiation areas near the sensors P14, P16 in the state shown in FIG. 21D. As shown in FIG. 21F, unlike the state shown in FIG. 21C, an upper end of the irradiation area b is positioned on the sensor P16. Further, unlike the state shown in FIG. 21C, an upper end of the irradiation area c is deviated rightward of the sensor P14, and is positioned on the sensor P16. With this arrangement, the output signal from the sensor P16 is increased, and the output signal from the sensor P14 is decreased, as compared with the state shown in FIG. 21A. Likewise, the output signal from the sensor P15 is increased, and the output signal from the sensor P13 is decreased, as compared with the state shown in FIG. 21A.

However, increased amounts of output signals from the sensors P16, P15, and decreased amounts of output signals from the sensors P14, P13 are small, as compared with the case where the light separating element H0 is used. Accordingly, even if the positions of the sensors P11 through P18 are displaced, it is possible to suppress degradation of the precision of output signals from the sensors P13 through P16, as compared with the case based on the above principle.

Further, even in the case where the positions of the sensors P11 through P18 are displaced rightward, it is possible to suppress lowering the precision of output signals from the sensors P13 through P16, as compared with the case where the light separating element H0 is used, although there is a change in the output signals from the sensors P13 through P16. Likewise, even in the case where the positions of the sensors P11 through P18 are displaced in a direction (upward or downward direction) in parallel to the direction of a track image, it is possible to suppress lowering the precision of output signals from the sensors P11, P12, P17, P18, as compared with the case where the light separating element H0 is used, although there is a change in the output signals from the sensors P11, P12, P17, P18.

Further, if the positions of the sensors P11 through P18 are displaced in leftward or rightward direction, the balance between output signals from the sensors P14, P16 is changed, and the balance between output signals from the sensors P13, P15 is changed. If the positions of the sensors P11 through P18 are displaced in upward or downward direction, the balance between output signals from the sensors P11, P12 is changed, and the balance between output signals from the sensors P17, P18 is changed. With this arrangement, it is possible to detect positional displacement amounts of the sensors P11 through P18 in upward/downward directions and leftward/rightward directions, based on imbalance amounts of output signals from the sensors P11, P12, the sensors P14, P16, the sensors P13, P15, and the sensors P17, P18. Thus, it is possible to adjust the positions of the sensors P11 through P18 by referring to the balance of output signals e.g. at the time of assembling an optical pickup device to thereby properly dispose the sensors P11 through P18.

In imparting a lens function to the light separating element H2, as shown in FIG. 19C, the light separating element H2 may have such a lens function that ends of the two irradiation areas positioned at four vertices of the signal light area, which are on the far side of the corresponding vertex of the signal light area, are set close to each other. In the above modification, it is also possible to obtain substantially the same advantage as the case where the irradiation area is distributed in the state as shown in FIG. 19B.

It is possible to obtain both the advantages of the light separating element H1 and the light separating element H2 by providing the light separating element H1 shown in FIG. 10A with the arrangement of the light separating element H2. In the following examples, there are described a concrete construction example of an optical pickup device, and light separating elements each of which has both the advantages of the light separating elements H1, H2.

### Example 1

The inventive example is an example, wherein the invention is applied to an optical pickup device compatible with BD, DVD and CD. The above principle is applied only to an optical system for BD, and a focus adjusting technology by a conventional astigmatism method and a tracking adjusting technology by a 3-beam system (an in-line system) are applied to an optical system for CD and an optical system for DVD.

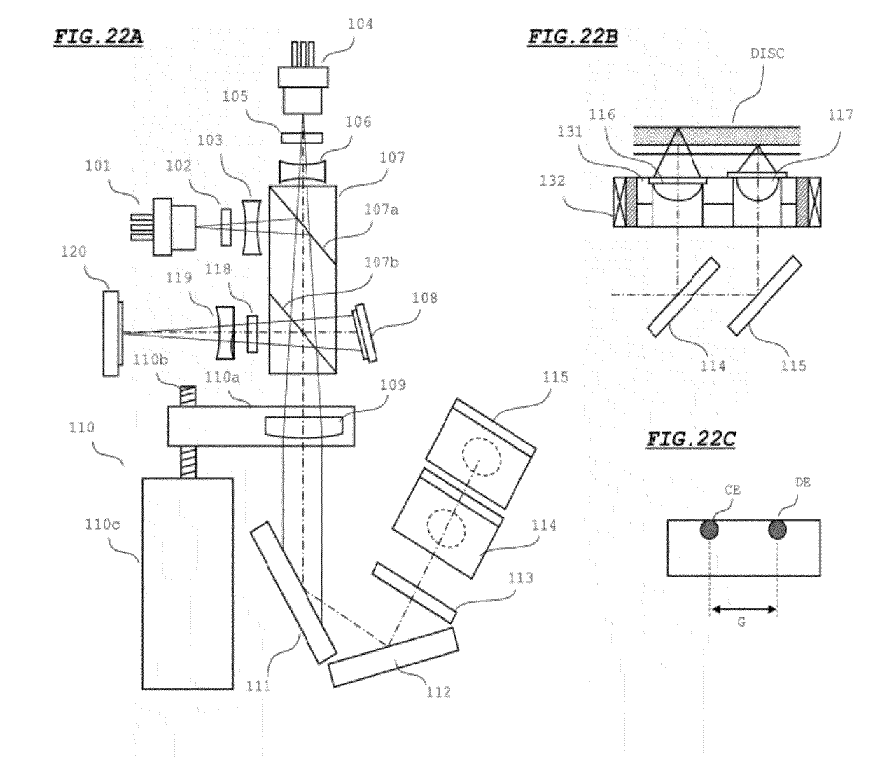

FIGS. 22A and 22B are diagrams showing an optical system of an optical pickup device in the inventive example. FIG. 22A is a plan view of the optical system showing a state that elements of the optical system on the disc side with respect to rise-up mirrors 114, 115 are omitted, and FIG. 22B is a perspective side view of the optical system posterior to the rise-up mirrors 114, 115.

As shown in FIG. 22A, the optical pickup device is provided with a semiconductor laser 101, a half wave plate 102, a diverging lens 103, a dual wavelength laser 104, a diffraction grating 105, a diverging lens 106, a complex prism 107, a front monitor 108, a collimator lens 109, a driving mechanism 110, reflection mirrors 111, 112, a quarter wave plate 113, the rise-up mirrors 114, 115, a dual wavelength objective lens 116, a BD objective lens 117, a light separating element 118, an anamorphic lens 119, and a photodetector 120.

The semiconductor laser 101 emits laser light (hereinafter, called as “BD light”) for BD and having a wavelength of or about 405 nm. The half wave plate 102 adjusts the polarization direction of BD light. The diverging lens 103 adjusts the focal length of BD light to shorten the distance between the semiconductor laser 101 and the complex prism 107.

The dual wavelength laser 104 accommodates, in a certain CAN, two laser elements which each emit laser light (hereinafter, called as “CD light”) for CD and having a wavelength of or about 785 nm, and laser light (hereinafter, called as “DVD light”) for DVD and having a wavelength of or about 660 nm.

FIG. 22C is a diagram showing an arrangement pattern of laser elements (laser light sources) in the dual wavelength laser 104. FIG. 22C is a diagram of the dual wavelength laser 104 when viewed from the beam emission side. In FIG. 22C, CE and DE respectively indicate emission points of CD light and DVD light. The gap between the emission points of CD light and DVD light is represented by the symbol G.

As will be described later, the gap G between the emission point CE of CD light and the emission point DE of DVD light is set to such a value as to properly irradiate DVD light onto a four-divided sensor for DVD light. Accommodating two light sources in one CAN as described above enables to simplify the optical system, as compared with an arrangement provided with plural CANs.

Referring back to FIG. 22A, the diffraction grating 105 separates each of CD light and DVD light into a main beam and two sub beams. The diffraction grating 105 is a two-step diffraction grating. Further, the diffraction grating 105 is integrally formed with a half wave plate. The half wave plate integrally formed with the diffraction grating 105 adjusts the polarization directions of CD light and DVD light. The diverging lens 106 adjusts the focal lengths of CD light and DVD light to shorten the distance between the dual wavelength laser 104 and the complex prism 107.

The complex prism 107 is internally formed with a dichroic surface 107a, and a Polarizing Beam Splitter (PBS) surface 107b. The dichroic surface 107a reflects BD light, and transmits CD light and DVD light. The semiconductor laser 101, the dual wavelength laser 104 and the complex prism 107 are disposed at such positions that the optical axis of BD light reflected on the dichroic surface 107a and the optical axis of CD light transmitted through the dichroic surface 107a are aligned with each other. The optical axis of DVD light transmitted through the dichroic surface 107a is displaced from the optical axes of BD light and CD light by the gap G shown in FIG. 22C.

A part of each of BD light, CD light and DVD light is reflected on the PBS surface 107b, and a main part thereof is transmitted through the PBS surface 107b. As described above, the half wave plate 102, and the diffraction grating 105 (and the half wave plate integrally formed with the diffraction grating 105) are disposed at such positions that a part of each of BD light, CD light and DVD light is reflected on the PBS surface 107b.

When the diffraction grating 105 is disposed at the position as described above, a main beam and two sub beams of CD light, and a main beam and two sub beams of DVD light are respectively aligned along the tracks of CD and DVD. The main beam and the two sub beams reflected on CD are irradiated onto four-divided sensors for CD on the photodetector 120, which will be described later. The main beam and two sub beams reflected on DVD are irradiated onto four-divided sensors for DVD on the photodetector 120, which will be described later.

BD light, CD light, DVD light reflected on the PBS surface 107b is irradiated onto the front monitor 108. The front monitor 108 outputs a signal in accordance with a received light amount. The signal from the front monitor 108 is used for emission power control of the semiconductor laser 101 and the dual wavelength laser 104.

The collimator lens 109 converts BD light, CD light and DVD light entered from the side of the complex prism 107 into parallel light. The driving mechanism 110 moves the collimator lens 109 in the optical axis direction in accordance with a control signal for aberration correction. The driving mechanism 110 is provided with a holder 110a for holding the collimator lens 109, and a gear 110b for feeding the holder 110a in the optical axis direction of the collimator lens 109. The gear 110b is interconnected to a driving shaft of a motor 110c.

BD light, CD light and DVD light collimated by the collimator lens 109 are reflected on the two reflection mirrors 111, 112, and are entered into the quarter wave plate 113. The quarter wave plate 113 converts BD light, CD light and DVD light entered from the side of the reflection mirror 112 into circularly polarized light, and converts BD light, CD light and DVD light entered from the side of the rise-up mirror 114 into a linearly polarized light whose polarization direction is orthogonal to the polarization direction upon incidence from the side of the reflection mirror 112. With this operation, light reflected on a disc is reflected on the PBS surface 107b.

The rise-up mirror 114 is a dichroic mirror. The rise-up mirror 114 transmits BD light, and reflects CD light and DVD light in a direction toward the dual wavelength objective lens 116. The rise-up mirror 115 reflects BD light in a direction toward the BD objective lens 117.

The dual wavelength objective lens 116 is configured to properly focus CD light and DVD light on CD and DVD, respectively. Further, the BD objective lens 117 is configured to properly focus BD light on BD. The dual wavelength objective lens 116 and the BD objective lens 117 are driven by an objective lens actuator 132 in a focus direction and in a tracking direction, while being held on the holder 110a.

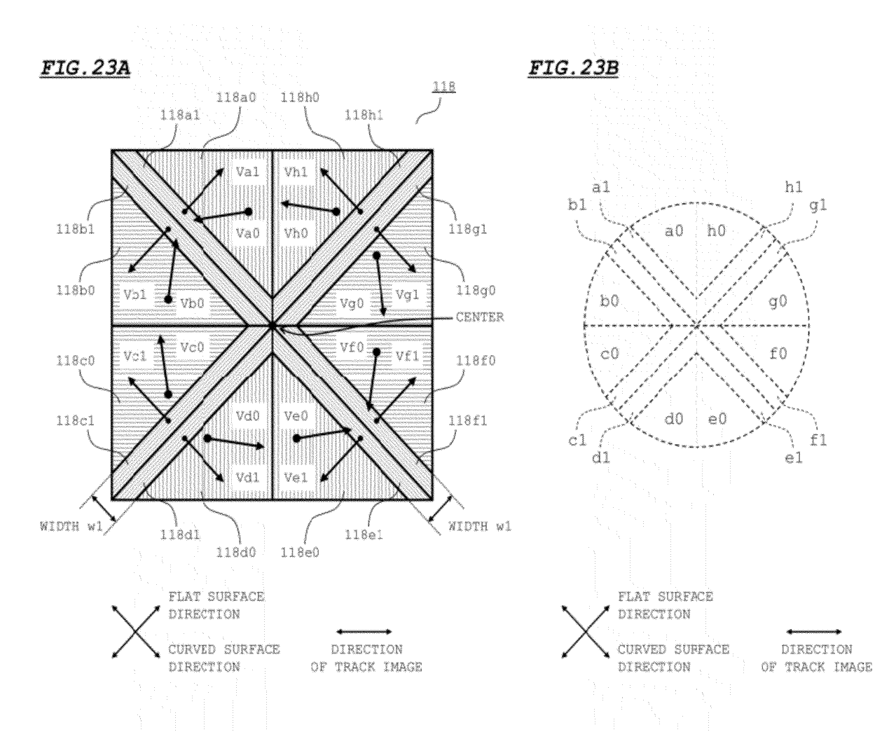

The light separating element 118 has a stepped diffraction pattern (a diffraction hologram) on an incident surface thereof. Out of BD light, CD light, and DVD light entered into the light separating element 118, BD light is divided into sixteen light fluxes, which will be described later, and the propagating direction of each of the light fluxes is changed by diffraction on the light separating element 118. Main parts of CD light and DVD light are transmitted through the light separating element 118 without diffraction on the light separating element 118. An arrangement of the light separating element 118 will be described later referring to FIG. 23A.

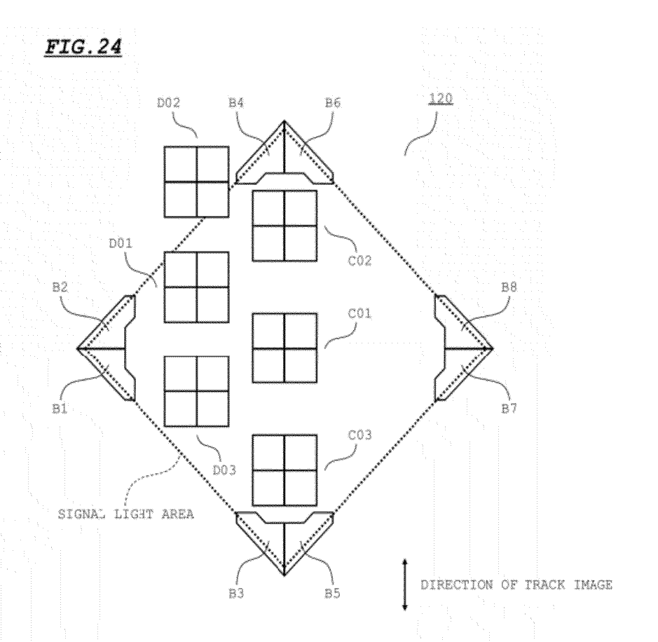

The anamorphic lens 119 imparts astigmatism to BD light, CD light and DVD light entered from the side of the light separating element 118. The anamorphic lens 119 corresponds to the anamorphic lens shown in FIGS. 1A and 1B. BD light, CD light and DVD light transmitted through the anamorphic lens 119 are entered into the photodetector 120. The photodetector 120 has a sensor layout for receiving the respective light. The sensor layout of the photodetector 120 will be described later referring to FIG. 24.

FIG. 23A is a diagram showing an arrangement of the light separating element 118. FIG. 23A is a plan view of the light separating element 118, when viewed from the side of the complex prism 107. FIG. 23A also shows the flat surface direction, the curved surface direction of the anamorphic lens 119, and a direction of a track image of laser light to be entered into the light separating element 118.

As shown in FIG. 23A, the light separating element 118 has a construction such that the light separating element H1 shown in FIG. 10A, and the light separating element H2 shown in FIG. 18A are combined. Specifically, eight diffraction areas 118a0 through 118h0 are formed by dividing each of the diffraction areas H1a through H1d of the light separating element H1 into two parts by a straight line in parallel to up and down directions or left and right directions. With this arrangement, the light separating element 118 is provided with sixteen diffraction areas 118a0 through 118h0, 118a1 through 118h1. Further, the diffraction directions of the diffraction areas 118a0 through 118h0 are set to directions Va0 through Vh0, which are aligned with those of the diffraction areas Va through Vh of the light separating element H2.

The step number and the step height of the diffraction pattern are set such that plus first order diffraction efficiency with respect to the wavelength of BD light is set high, and that zero-th order diffraction efficiency with respect to the wavelengths of CD light and DVD light is set high. Further, the light separating element 118 is disposed in such a manner that the center of the light separating element 118 is aligned with an optical axis of BD light. With this arrangement, the light flux areas a0 through h0, a1 through h1 shown in FIG. 23B are respectively entered into the diffraction areas 118a0 through 118h0, 118a1 through 118h1.

The diffraction areas 118a0 through 118h0 respectively diffract the entered BD light into the directions Va0 through Vh0 by plus first order diffraction function in the same manner as the state shown in FIG. 18A. Further, each of the diffraction areas 118a0 through 118h0 diffracts BD light by the same diffraction angle by plus first order diffraction function. Likewise, each of the diffraction areas 118a1 through 118h1 diffracts BD light by the same diffraction angle by plus first order diffraction function. The diffraction angle is adjusted by the pitch of a diffraction pattern.

The diffraction areas 118a0 through 118h0, 118a1 through 118h1 are formed by a diffraction pattern having e.g. eight steps. In this case, the step difference per step is set to 7.35 μm. With this arrangement, it is possible to set the diffraction efficiencies of zero-th order diffraction light of CD light and DVD light to 99% and 92% respectively, while keeping the diffraction efficiency of plus first order diffraction light of BD light to 81%. In this case, zero-th order diffraction efficiency of BD light is set to 7%. CD light and DVD light are irradiated onto four-divided sensors on the photodetector 120, which will be described later, substantially without diffraction on the diffraction areas 118a0 through 118h0, 118a1 through 118h1.

Alternatively, it is possible to set the number of steps of a diffraction pattern to be formed in the diffraction areas 118a0 through 118h0, 118a1 through 118h1 to the number other than eight. Furthermore, it is possible to configure the diffraction areas 118a0 through 118h0, 118a1 through 118h1 by using e.g. the technology disclosed in Japanese Unexamined Patent Publication No. 2006-73042. Using the above technology enables to more finely adjust diffraction efficiencies of BD light, CD light and DVD light.

FIG. 24 is a diagram showing a sensor layout of the photodetector 120.

The photodetector 120 has sensors B1 through B8 for BD and for receiving BD light separated by the light separating element 118; four-divided sensors C01 through C03 for CD and for receiving CD light transmitted through the light separating element 118 without separation by the light separating element 118; and four-divided sensors D01 through D03 for DVD and for receiving DVD light transmitted through the light separating element 118 without separation by the light separating element 118. Signal light of BD light separated by the light separating element 118 is irradiated onto a vertex portion of a signal light area.

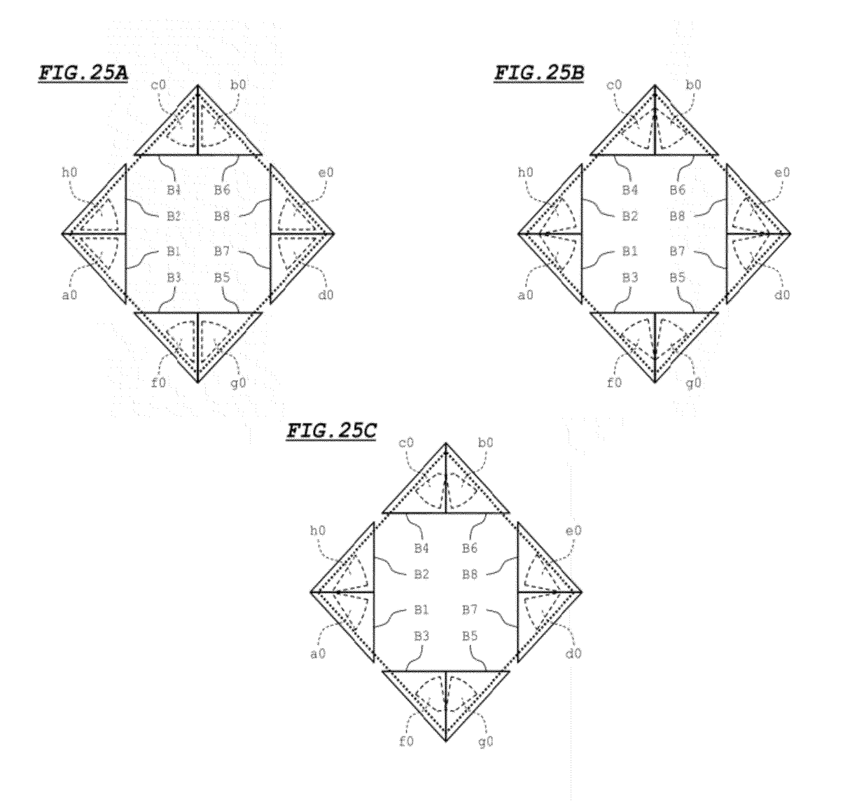

As shown in FIG. 24, the sensors B1, B2, the sensors B3, B5, the sensors B4, B6, the sensors B7, B8 are disposed near the four vertices of the signal light area to receive signal light of BD light passing through the light flux areas a0 through h0, respectively. The sensors B1 through B8 are disposed at such positions that the irradiation area of BD light which is positioned on the inside of the four vertex portions of the signal light area is sufficiently included. With this arrangement, it is possible to sufficiently receive signal light separated by the light separating element 118 by the sensors B1 through B8, even in the case where the positions of the sensors B1 through B8 are displaced resulting from e.g. aging deterioration. The irradiation area of signal light of BD light will be described later, referring to FIG. 25A.

The optical axes of BD light and CD light are aligned with each other on the dichroic surface 107a as described above. Accordingly, a main beam (zero-th order diffraction light) of CD light is irradiated onto a center of the signal light area of BD light, on the light receiving surface of the photodetector 120. The four-divided sensor C01 is disposed at the center position of a main beam of CD light. The four-divided sensors C02, C03 are disposed in the direction of a track image with respect to a main beam of CD light, on the light receiving surface of the photodetector 120, to receive sub beams of CD light.

Since the optical axis of DVD light is displaced from the optical axis of CD light as described above, a main beam and two sub beams of DVD light are irradiated at positions displaced from the irradiation positions of a main beam and two sub beams of CD light, on the light receiving surface of the photodetector 120. The four-divided sensors D01 through D03 are respectively disposed at the irradiation positions of a main beam and two sub beams of DVD light. The distance between a main beam of CD light and a main beam of DVD light is determined by the gap G between emission points of CD light and DVD light shown in FIG. 22C.

FIG. 25A is a schematic diagram showing an irradiation area of BD light, in the case where BD light passing through the light flux areas a0 through h0 shown in FIG. 23B, is irradiated onto the sensors B1 through B8 shown in FIG. 24. FIG. 25A is a diagram showing signal light of BD light to be irradiated onto the sensors B1 through B8, in the case where the focus position of BD light is adjusted on a target recording layer. To simplify the description, the irradiation areas of BD light passing through the light flux areas a0 through h0 on the photodetector 120 are indicated as irradiation areas a0 through h0. Further, to simplify the description, the shape of the sensors B1 through B8 shown in FIG. 25A is simplified in comparison with the shape of the sensors B1 through B8 shown in FIG. 24.

As shown in FIG. 25A, signal light of BD light passing through the light flux areas a0 through h0 is respectively irradiated onto the sensors B1, B6, B4, B7, B8, B3, B5, B2. At the time of the irradiation, stray light 1, 2 of BD light passing through the light flux areas a0 through h0 are irradiated to a position on the outside of the signal light area substantially in the same manner as the state shown in FIG. 4B. Further, signal light and stray light 1, 2 of BD light passing through the light flux areas a1 through h1 are irradiated to a position on the outside of the signal light area substantially in the same manner as the state shown in FIGS. 11A through 11C.

In this example, since the light separating element 118 has a construction such that the light separating element H1 shown in FIG. 10A and the light separating element H2 shown in FIG. 18A are combined, the irradiation areas a0 through h0 have such a shape that the light separating elements H1, H2 exhibit the aforementioned function.

Specifically, the irradiation areas a0 through h0 are positioned on the inside of the signal light area in accordance with the width w1 (see FIG. 23A) of the diffraction areas 118a1 through 118h1. With this arrangement, there is no or less likelihood that stray light 1, 2 may be irradiated onto the sensors B1 through B8, which makes it easy to discriminate a recording layer, and easy to isolate a target S-shaped curve.

Further, the irradiation area a0 and the irradiation area h0 are away from each other in up and down directions by a predetermined distance, with a boundary portion between the sensor B1 and the sensor B2 being formed therebetween. The irradiation area b and the irradiation area c are away from each other in left and right directions by a predetermined distance, with a boundary portion between the sensor B6 and the sensor B4 being formed therebetween. The irradiation area d and the irradiation area e are away from each other in up and down directions by a predetermined distance, with a boundary portion between the sensor B7 and the sensor B8 being formed therebetween. The irradiation area f and the irradiation area g are away from each other in left and right directions by a predetermined distance, with a boundary portion between the sensor B3 and the sensor B5 being formed therebetween. With this arrangement, there is no or less likelihood that output signals from the sensors B1 through B8 may vary, even if the positions of the sensors B1 through B8 are displaced, as compared with a state before displacement occurs.

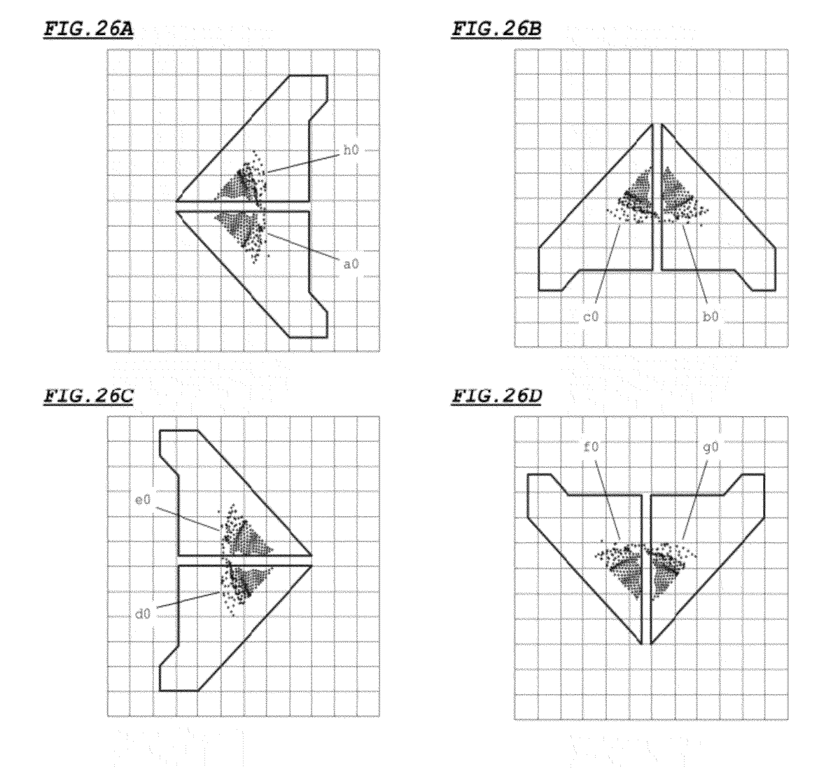

FIGS. 26A through 26D are diagrams showing simulation results of an irradiation area on the sensor layout of the photodetector 120. FIGS. 26A through 26D are respectively enlarged views of a left portion, an upper portion, a right portion, and a lower portion of the sensor layout, showing an irradiation area of signal light on the photodetector 120. It is clear that the irradiation areas a0 through h0 of signal light in this example are positioned on the sensors B1 through B8 in the same manner as the state shown in FIG. 25A.

As described above, according to Example 1, as shown in FIG. 25A and FIGS. 26A through 26D, the irradiation area of signal light of BD light is distributed on the inside of the four vertex portions of the signal light area, and the irradiation areas of stray light 1, 2 of BD light are distributed on the outside of the signal light area substantially in the same manner as the state shown in FIG. 4B. Accordingly, it is possible to receive only signal light of BD light by the sensors B1 through B8 shown in FIG. 24. Thus, it is possible to suppress degradation of a detection signal resulting from stray light.

Further, according to Example 1, there is no or less likelihood that stray light 1, 2 may overlap signal light of BD light, as compared with the case where the light separating element H0 is used. Thus, the above arrangement enables to enhance the precision of output signals from the sensors B1 through B8 based on signal light of BD light.

Furthermore, according to Example 1, a fall of a SUM signal between recording layers is large, as compared with the case where the light separating element H0 is used. Thus, the above arrangement makes it easy to discriminate a target recording layer from among plural recording layers.

In addition, according to Example 1, the detection range of an S-shaped curve of a focus error signal FE is narrow, as compared with the case where the light separating element H0 is used. Thus, the above arrangement enables to quickly adjust the focus position of laser light onto a target recording layer, after the laser light is focused on the target recording layer.

In addition, according to Example 1, even if the positions of the sensors B1 through B8 are displaced, unlike the case where the light separating element H0 is used, there is no or less likelihood that the output signal from each sensor may vary. Thus, even if the positions of the sensors B1 through B8 are displaced by e.g. aging deterioration, it is possible to suppress degradation of output signals from the sensors B1 through B8.

### Example 2

In this example, a light separating element 121 is used, in place of the light separating element 118 used in Example 1. The arrangement of the optical system of the optical pickup device in this example is substantially the same as that in Example 1, except for the light separating element 121.

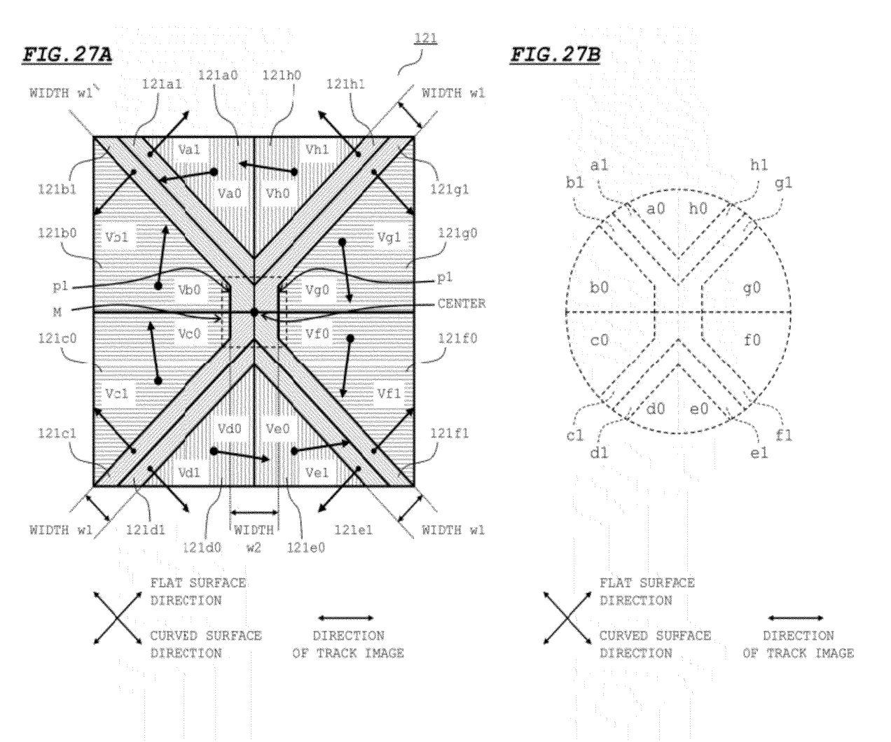

FIG. 27A is a diagram showing an arrangement of the light separating element 121. FIG. 27A is a plan view of the light separating element 121 when viewed from the side of a complex prism 107. FIG. 27A also shows the flat surface direction, the curved surface direction of the anamorphic lens, and the direction of a track image of laser light to be entered into the light separating element 121.

As shown in FIG. 27A, unlike the light separating element 118 shown in FIG. 23A, in the light separating element 121, the borderline between a diffraction area 121b1 and a diffraction areas 121b0 includes a vertically extending straight portion p1 near the center of the light separating element 121. Likewise, the borderline between a diffraction area 121c1 and a diffraction area 121c0, the borderline between a diffraction area 121f1 and a diffraction area 121f0, and the borderline between a diffraction area 121g1 and a diffraction area 121g0 each includes a vertically extending straight portion p1 near the center of the light separating element 121. The straight portions p1 in proximity to the diffraction areas 121b0, 121c0, and the straight portions p1 in proximity to the diffraction areas 121f0, 121g0 are symmetrically positioned with respect to the center of the light separating element 121, with the center of the light separating element 121 being interposed therebetween. With this arrangement, there is formed an area M which is constituted only of parts of the diffraction areas 121b1, 121c1, 121f1, 121g1 between the straight portions p1 in proximity to the diffraction area 121b0, 121c0, and the straight portions p1 in proximity to the diffraction areas 121f0, 121g0. Further, the width of the area M in left and right directions is set to w2.

The borderline between the diffraction areas 121a1, 121b1 passes on the upper side with respect to the center of the light separating element 121, and extends in parallel to the curved surface direction. The borderline between the diffraction areas 121e1, 121f1 passes on the lower side with respect to the center of the light separating element 121, and extends in parallel to the curved surface direction. Further, the borderline between the diffraction areas 121c1, 121d1 passes on the lower side with respect to the center of the light separating element 121, and extends in parallel to the flat surface direction. The borderline between the diffraction areas 121g1, 121h1 passes on the upper side with respect to the center of the light separating element 121, and extends in parallel to the flat surface direction. Thus, the diffraction areas 121a0 through 121h0, 121a1 through 121h1 are configured and arranged in the state as shown in FIG. 27A.

Light corresponding to the light flux areas a0 through h0, a1 through h1 shown in FIG. 27B is respectively entered into the diffraction areas 121a0 through 121h0, 121a1 through 121h1. Further, the diffraction areas 121a0 through 121h0 are provided with a lens function. This enables to set one ends of the irradiation areas in proximity to each other, of the irradiation areas on the sensors B1 through B8, close to each other, as shown in FIG. 25C.

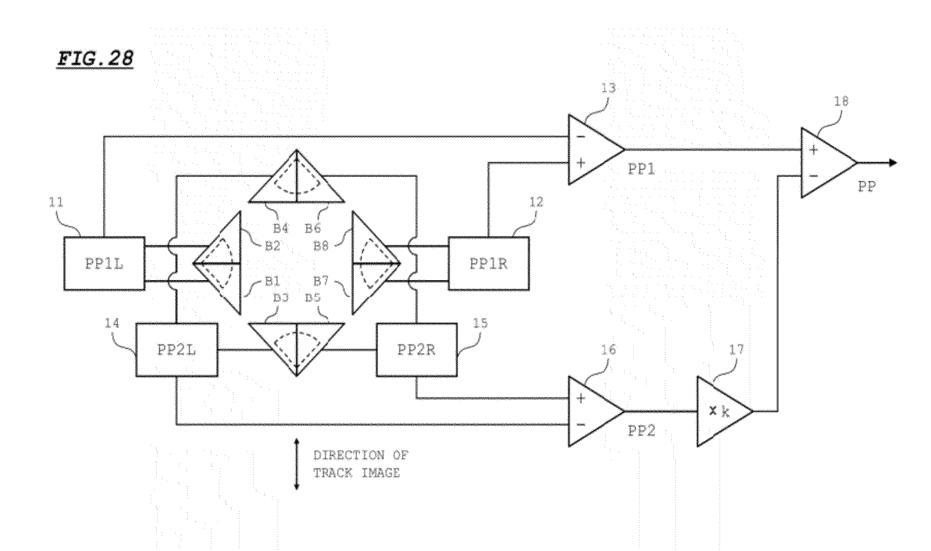

In the above arrangement, if the BD objective lens 117 is shifted in a direction perpendicular to the direction of a track image with respect to the optical axis of BD light in generating a push-pull signal PP based on the equation (2) described referring to FIG. 5D, an offset (a DC component) is superimposed on the push-pull signal PP. A method for suppressing an offset (a DC component) of a push-pull signal PP resulting from shift of the BD objective lens 117 (hereinafter, called as “lens shift”) as described above is disclosed in Japanese Unexamined Patent Publication No. 2010-102813 (corresponding to U.S. Patent Application Publication No. US2010/0080106 A1) of the patent application filed by the applicant of the present application. The method is described referring to FIG. 28.

FIG. 28 is a diagram showing a circuit configuration for suppressing an offset (a DC component) of a push-pull signal PP. The push-pull signal generation circuit in the above case is provided with adder circuits 11, 12, 14, 15, subtractor circuits 13, 16, 18, and a multiplier circuit 17.

The adder circuit 11 sums up output signals from the sensors B1, B2, and outputs a signal PP1L in accordance with the light amount of left-side signal light. The adder circuit 12 sums up output signals from the sensors B7, B8, and outputs a signal PP1R in accordance with the light amount of right-side signal light. The subtractor circuit 13 computes a difference between output signals from the adder circuits 11, 12, and generates a signal PP1 based on a light amount difference between the left and right two signal light.

The adder circuit 14 sums up output signals from the sensors B3, B4, and outputs a signal PP2L in accordance with the light amount of left-side signal light of upper and lower two signal light. The adder circuit 15 sums up output signals from the sensors B5, B6, and outputs a signal PP2R in accordance with the light amount of right-side signal light of upper and lower two signal light. The subtractor circuit 16 computes a difference between output signals from the adder circuits 14, 15, and generates a signal PP2 based on a light amount difference in left and right directions between the upper and lower two signal light.

The multiplier circuit 17 outputs a signal obtained by multiplying the signal PP2 to be outputted from the subtractor circuit 16 with a variable k to the subtractor circuit 18. The subtractor circuit 18 subtracts a signal to be input from the multiplier circuit 17, from the signal PP1 to be input from the subtractor circuit 13; and outputs a signal after the subtraction as a push-pull signal PP. The variable k is set to such a value that an offset (a DC component) of the signal PP1 by lens shift is cancelled out by the signal PP2 multiplied with the variable k. In this way, an offset (a DC component) of the push-pull signal PP is suppressed.

In the above arrangement, if there is a large difference between the signal PP1 and the signal PP2, the value of the variable k is set to a large value. In such a case, for instance, if noise is included in the signal PP2 resulting from slight incidence of stray light into a sensor, the signal PP2 including the noise may be multiplied with the variable k which is set to a large value. As a result, an influence of noise on the push-pull signal PP may be seriously increased.

However, as shown in FIG. 27A, the light separating element 121 in this example is configured such that the surface areas of the diffraction areas 121b0, 121c0, 121f0, 121g0 are respectively set larger than the surface areas of the diffraction areas 121a0, 121d0, 121e0, 121h0. Accordingly, the surface areas of the irradiation areas b0, c0, f0, g0 on the sensors B1 through B8 shown in FIG. 25C are respectively set larger than the surface areas of the irradiation areas a0, d0, e0, h0. Therefore, it is possible to make the signals PP1L, PP1R shown in FIG. 28 small, and make the signals PP2L, PP2R shown in FIG. 28 large, as compared with the case where the irradiation areas are substantially uniformly distributed on the sensors P11 through P18 as shown in FIG. 7D. Thus, the difference between the signal PP1 and the signal PP2 is reduced, and therefore, it is possible to set the variable k to a small value, as compared with the case where the light separating element H0 is used.

Next, there is described a change in a signal resulting from shift of an irradiation area on the light separating element H0 and on the light separating element 121 in this example, in the case where there is lens shift in the BD objective lens 117.

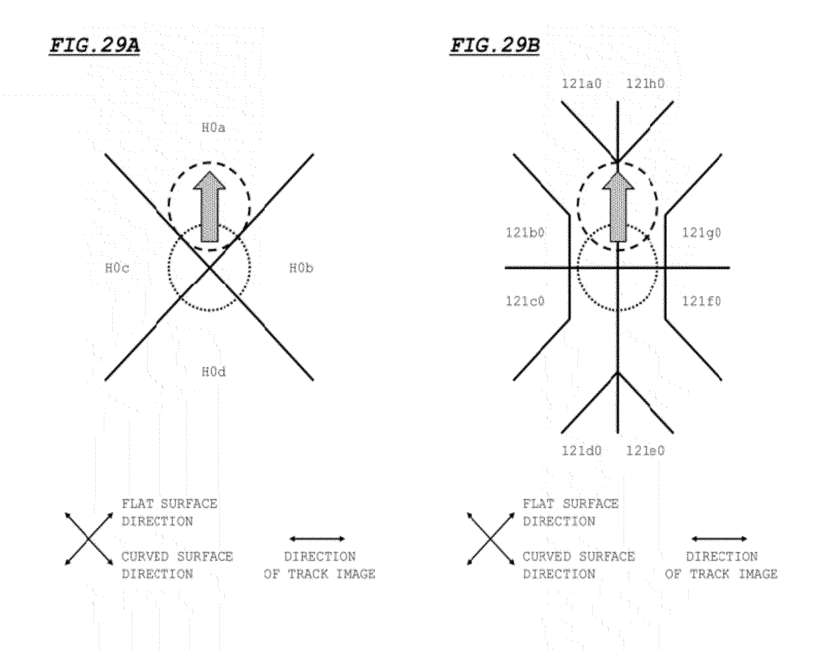

FIGS. 29A, 29B are respectively enlarged views of center portions, on the irradiation areas of light fluxes to be entered into the light separating element H0 and into the light separating element 121, where the light intensity is high. Referring to FIGS. 29A, 29B, the dotted-line circle indicates a center portion where the light intensity is high, in the case where there is no lens shift; and the dashed-line circle indicates a center portion where the light intensity is high, in the case where there is lens shift.

Referring to FIG. 29A, if there is lens shift, a portion of an irradiation area on the light separating element H0, where the light intensity is high, is displaced upward. In this case, since the overlapping area on the diffraction areas H0b, H0c is decreased, the value of the signal PP2 corresponding to the diffraction areas H0b, H0c may be greatly changed.

On the other hand, referring to FIG. 29B, if there is lens shift, a portion of an irradiation area on the light separating element 121, where the light intensity is high, is displaced upward. In this case, the value of the signal PP2 corresponding to the diffraction areas 121b0, 121c0, 121f0, 121g0 is not greatly changed, because there is no overlapping between the portion of the irradiation area where the light intensity is high, and the diffraction areas 121b0, 121c0, 121f0, 121g0, both in the case where there is lens shift and in the case where there is no lens shift. Accordingly, it is possible to more linearly change the value of the signal PP2 by lens shift, as compared with the state shown in FIG. 29A.

In the above arrangement, the value of the signal PP1 is substantially linearly changed by lens shift. Accordingly, it is possible to more effectively suppress an offset (a DC component) included in the signal PP1 by using the value of the signal PP2 which is linearly changed. Thus, it is possible to more effectively suppress an offset (a DC component) of the push-pull signal PP by setting an area which is interposed between the straight portions p1, at a position near the center on the diffraction areas of the light separating element.

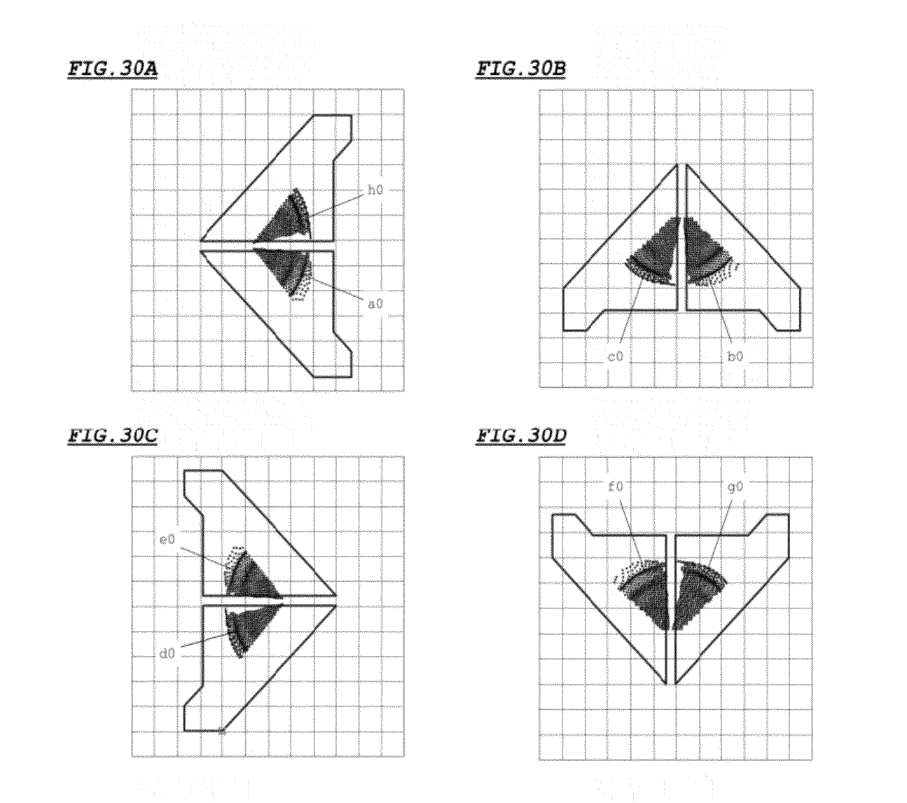

FIGS. 30A through 30D are diagrams showing simulation results of an irradiation area on the sensor layer of the photodetector 120. FIGS. 30A through 30D are respectively enlarged views of a left portion, an upper portion, a right portion, and a lower portion of the sensor layout, showing an irradiation area of signal light on the photodetector 120. It is clear that the irradiation areas a0 through h0 of signal light in this example are positioned on the sensors B1 through B8 in the same manner as the state shown in FIG. 25C.

As described above, according to Example 2 of the invention, as shown in FIG. 27A, the surface areas of the irradiation areas 121b0, 121c0, 121f0, 121g0 are respectively set larger than the surface areas of the irradiation areas 121a0, 121d0, 121e0, 121h0. Accordingly, it is possible to make the signals PP1L, PP1R shown in FIG. 28 small, and make the signals PP2L, PP2R shown in FIG. 28 large. Thus, the difference between the signal PP1 and the signal PP2 is reduced, and therefore, it is possible to set the variable k to a small value, as compared with the case where the light separating element H0 is used.

Further, according to Example 2 of the invention, there is formed a vertically extending area M which is constituted only of parts of the diffraction areas 121b1, 121c1, 121f1, 121g1 in the center on the light separating element 121. With this arrangement, there is no likelihood that a portion of an irradiation area where the light intensity is high may overlap the diffraction areas 121b0, 121c0, 121f0, 121g0, irrespective of the presence or absence of lens shift. Thus, it is possible to suppress a change in the value of the signal PP2. Since the value of the signal PP2 by lens shift is more linearly changed, the above arrangement is advantageous in more effectively suppressing an offset (a DC component) of the push-pull signal PP.

Furthermore, according to Example 2 of the invention, as shown in FIG. 25C or FIGS. 30A through 30D, the inner portions of the two irradiation areas which are distributed on the four vertex portions of the signal light area are away from each other, with a clearance between the corresponding two sensors being formed therebetween. With this arrangement, there is no or less likelihood that output signals from the sensors B1 through B8 may be degraded, even if the positions of the sensors B1 through B8 are displaced. Further, the outer portions of the two irradiation areas which are distributed on the four vertex portions of the signal light area are close to each other, with a clearance between the corresponding two sensors being formed therebetween. With this arrangement, positional adjustment of the sensors B1 through B8 on the plane S0 can be performed by referring to the output signals from the sensors B1 through B8. This is advantageous in properly disposing the sensors B1 through B8.

The example of the invention has been described as above. The invention is not limited to the foregoing example, and the example of the invention may be modified in various ways other than the above.

For instance, in the foregoing examples, BD light is separated by using the light separating element 118 or 121 which is configured such that a diffraction pattern is formed on a light incident surface thereof. Alternatively, BD light may be separated by using a light separating element constituted of a multifaceted prism, in place of using the light separating element 118 or 121. Plural surfaces corresponding to the diffraction areas of the light separating element 118 or 121 are formed on a light incident surface of the multifaceted prism. With this arrangement, signal light of BD light is irradiated onto the light receiving surface in the same manner as the case where the light separating element 118 or 121 is used.

In the case where a light separating element constituted of a multifaceted prism is used, the optical system for receiving BD light, and the optical system for receiving CD light and DVD light may be individually constructed. Specifically, BD light is guided to the BD objective lens 117 shown in FIG. 22B by the optical system for BD, and CD light and DVD light are guided to the dual wavelength objective lens 116 shown in FIG. 22B by the optical system for CD/DVD which is constructed independently of the optical system for BD. The optical system for BD has a laser light source for emitting BD light, and a photodetector for receiving BD light reflected on BD. The optical system for CD/DVD has a laser light source for emitting CD light and DVD light, and a photodetector other than the photodetector for BD light and for receiving CD light, DVD light reflected on CD, DVD. The photodetector for CD/DVD has two sensor groups for individually receiving CD light and DVD light. Similarly to the foregoing examples, the optical system for BD is provided with an anamorphic lens for imparting astigmatism to BD light reflected on BD. The light separating element constituted of a multifaceted prism is disposed anterior to the anamorphic lens.

Further, in the foregoing examples, the light separating element 118, 121 is disposed anterior to the anamorphic lens 119. Alternatively, the light separating element 118, 121 may be disposed posterior to the anamorphic lens 119. Further alternatively, a diffraction pattern for imparting substantially the same diffraction function as the light separating element 118, 121 to laser light may be integrally formed on the incident surface or on the output surface of the anamorphic lens 119.

Furthermore, in the foregoing examples, BD light is diffracted on diffraction areas adjacent to each other, of the diffraction areas 118a1 through 118h1, 121a1 through 121h1, respectively in directions in parallel to the flat surface direction or in parallel to the curved surface direction, and displaced from each other by 180 degrees. Alternatively, the diffraction directions may be set, as necessary, in such a manner that diffracted BD light is not irradiated onto the sensors B1 through B8. Further alternatively, diffraction areas adjacent to each other, of the diffraction areas 118a1 through 118h1, 121a1 through 121h1, may be integrally formed into one diffraction area. In the modification, the diffraction directions may also be set, as necessary, in such a manner that diffracted BD light is not irradiated onto the sensors B1 through B8.

In addition, in the foregoing examples, the diffraction areas 118a1 through 118h1 each having the width w1 are formed on the light separating element 118, and the diffraction areas 121a1 through 121h1 each having the width w1 are formed on the light separating element 121. Alternatively, the diffraction areas 118a1 through 118h1, 121a1 through 121h1 may be formed with a light blocking portion where incidence of laser light is blocked. In the modification, signal light of BD light is irradiated onto the sensors B1 through B8 in the same manner as the foregoing examples. In the modification, the light amount of CD light to be irradiated onto the four-divided sensors C01 through C03, and the light amount of DVD light to be irradiated onto the four-divided sensors D01 through D03 are reduced by the light blocking portions. In the case where the reduction in the light amount of CD light and DVD light causes a problem, the optical system for receiving BD light, and the optical system for receiving CD light and DVD light may be individually constructed.

In the foregoing examples, the light separating element 118, 121 is a transmissive diffraction grating capable of transmitting light. Alternatively, the light separating element 118, 121 may be configured into a reflective diffraction grating having a reflection surface. In the modification, for instance, the light separating element may be configured such that light reflected on the reflection surface of the light separating element is guided to the photodetector 120 via the anamorphic lens 119 by inclining the light separating element by 45 degrees with respect to the optical axis.

The embodiment of the invention may be changed or modified in various ways as necessary, as far as such changes and modifications do not depart from the scope of the claims of the invention hereinafter defined.

What is claimed is:

1. An optical pickup device, comprising:
a laser light source;
an objective lens which focuses laser light emitted from the laser light source on a recording medium;
an astigmatism element into which reflected light of the laser light reflected on the recording medium is entered, and which converges the reflected light in a first direction to generate a first focal line, and converges the reflected light in a second direction perpendicular to the first direction to generate a second focal line;
a light separating element into which the reflected light is entered, and which separates light fluxes of the reflected light entered into four first areas from each other; and
a photodetector which receives the separated light fluxes to output a detection signal, wherein
assuming that an intersection of first and second straight lines respectively in parallel to the first direction and the second direction and intersecting with each other is aligned with a center of the light separating element, two of the first areas are disposed in a direction along which a pair of vertically opposite angles defined by the first and second straight lines are aligned, and the other two of the first areas are disposed in a direction along which the other pair of vertically opposite angles defined by the first and second straight lines are aligned,
the four first areas are divided by a second area having a predetermined width,
each of the four first areas is divided into two segment areas by a third straight line intersecting the first and second straight lines at an angle of 45 degrees, or a fourth straight line perpendicularly intersecting the third straight line,
the light separating element is configured in such a manner that the reflected light to be entered into the second area is guided to a position on the outside of sensors of the photodetector, and is configured in such a manner that light fluxes of the reflected light to be entered into the paired segment areas are irradiated, on the photodetector, at positions away from each other by a predetermined clearance, and
the photodetector is provided with the sensors which individually receive a light flux to be entered into each of the segment areas.

2. The optical pickup device according to claim 1, wherein
the light separating element changes a propagating direction of the reflected light to be entered into the second area for guiding the reflected light to be entered into the second area to the position on the outside of the sensors, and
an angle by which the propagating direction of the reflected light is changed by the second area is set larger than an angle by which the propagating direction of the reflected light is changed by the first area.

3. The optical pickup device according to claim 1, wherein
the light separating element sets a propagating direction of a light flux of the reflected light to be entered into the paired segment areas in such a manner that a clearance, on the photodetector, between the light fluxes of the reflected light to be entered into the paired segment areas is set larger than a clearance between the two sensors which receive the two light fluxes.

4. The optical pickup device according to claim 3, wherein
the light separating element imparts, to the light fluxes of the reflected light to be entered into the paired segment areas, an optical function of gradually decreasing the clearance, on the photodetector, between the light fluxes of the reflected light to be entered into the paired segment areas, in a direction of a parting line of the two sensors which receive the two light fluxes.

5. The optical pickup device according to claim 1, wherein
a surface area of two first areas, of the four first areas, which are disposed in a direction in parallel to a direction of a track image of the recording medium projected onto the light separating element is set larger than a surface area of the other two first areas which are disposed in a direction perpendicular to the direction of the track image of the recording medium projected onto the light separating element.

6. The optical pickup device according to claim 1, wherein
the second area has a third area on the center of the light separating element, the third area extending in a direction perpendicular to a direction of a track image of the recording medium projected onto the light separating element.
